(19) United States
(12) Patent Application Publication
(10) Pub. No.: US 2014/0061540 A1
(43) Pub. Date: Mar. 6, 2014

(54) METAL-ORGANIC FRAMEWORK ADSORBENTS FOR COMPOSITE GAS SEPARATION

(71) Applicant: THE REGENTS OF THE UNIVERSITY OF CALIFORNIA, Oakland, CA (US)

(72) Inventors: Jeffrey R. Long, Oakland, CA (US); Zoey R. Herm, Berkeley, CA (US); Joseph A. Swisher, Berkeley, CA (US); Berend Smit, Berkeley, CA (US); Rajamani Krishna, Amsterdam (NL); Eric Bloch, Berkeley, CA (US); Leslie Murray, Gainesville, FL (US)

(73) Assignee: THE REGENTS OF THE UNIVERSITY OF CALIFORNIA, Oakland, CA (US)

(21) Appl. No.: 13/965,098

(22) Filed: Aug. 12, 2013

Related U.S. Application Data
(63) Continuation of application No. PCT/US2012/028006, filed on Mar. 7, 2012.
(60) Provisional application No. 61/450,048, filed on Mar. 7, 2011.
(60) Provisional application No. 61/527,331, filed on Aug. 25, 2011.

(51) Int. Cl. B01J 20/22; C01B 3/56; B01J 20/30; C01B 3/22

(52) U.S. Cl. CPC B01J 20/226; C01B 3/22; C01B 3/56; B01J 20/3085
USPC 252/373; 423/210; 423/226; 423/219; 423/239.1; 423/245.1; 423/247; 252/182.12; 423/648.1; 556/147; 585/3

(57) ABSTRACT

Metal-organic frameworks of the family M₂ (2,5-dioxido-1,4-benzenedicarboxylate) wherein M=Mg, Mn, Fe, Co, Cu, Ni or Zn are a group of porous crystalline materials formed of metal cations or clusters joined by multitopic organic linkers that can be used to isolate individual gases from a stream of combined gases. This group of adsorbant materials incorporates a high density of coordinatively-unsaturated M^{II} centers lining the pore surfaces. These adsorbents are particularly suited for selective carbon dioxide/monoxide adsorption via pressure swing adsorption near temperatures of 313 K since they selectively adsorb carbon dioxide at high pressures in the presence of hydrogen, and desorb carbon dioxide upon a pressure decrease. The redox-active Fe^{II} centers in Fe₂(dobdc) can be used for the separation of O₂ from N₂ and other separations based on selective, reversible electron transfer reactions. Gas storage, such as acetylene storage, and catalysis, such as oxidation, are also useful applications of these materials.

### CROSS-REFERENCE TO RELATED APPLICATIONS

This application is a 35 U.S.C. §111(a) continuation of PCT international application number PCT/US2012/028006 filed on Mar. 7, 2012, incorporated herein by reference in its entirety, which is a nonprovisional of U.S. provisional patent application Ser. No. 61/450,048 filed on Mar. 7, 2011, incorporated herein by reference in its entirety, and a nonprovisional of U.S. provisional patent application Ser. No. 61/527,331 filed on Aug. 25, 2011, incorporated herein by reference in its entirety. Priority is claimed to each of the foregoing applications.

The above-referenced PCT international application was published as PCT International Publication No. WO 2012/122233 on Sep. 13, 2012 and republished on Dec. 27, 2012, and is incorporated herein by reference in its entirety.

### STATEMENT REGARDING FEDERALLY SPONSORED RESEARCH OR DEVELOPMENT

This invention was made with Government support under Grant No. DE-SC0001015 awarded by the Department of Energy. The Government has certain rights in this invention.

### INCORPORATION-BY-REFERENCE OF MATERIAL SUBMITTED ON A COMPACT DISC

Not Applicable

### BACKGROUND OF THE INVENTION

1. Field of Invention

This invention pertains to the use of metal-organic frameworks as adsorbents for the separation of composite gasses, and more particularly to adsorbents with a high concentration of metal cation sites in the metal organic framework and methods for the separation of a variety of materials based on selective, reversible electron transfer reactions. For example, methods are provided for the separation of individual gases from as stream of combined gases such as O₂ from N₂ gases or CO₂ from H₂ gases from a stream of combined gases. In addition, the adsorbents can be used for many other separation processes, including paraffin/olefin separations, nitric oxide/nitrous oxide separation, acetylene storage, and as an oxidation catalyst.

2. Background

The need for the efficient separation of gas mixtures into their component parts appears in many different industrial processes including energy production and emission reduction. Many gas separations are presently performed on large scales in numerous industrial processes and so improvements will lead to global energy savings. Additionally, carbon capture and storage is an exciting possibility for preventing the release of anthropogenic carbon dioxide into the atmosphere and hinges on gas separations at its core. Current gas separation processes are not sufficiently advanced to render carbon capture a viable addition to power plants. As a result, optimizing gas separations is a pragmatic approach to solving contemporary energy-related problems.

Hydrocarbons are ubiquitous in industrial processes and are invaluable as both fuel (gasoline and natural gas) and feedstocks (plastics). Many hydrocarbons are found as mixtures or are byproducts of one another. Due to the narrow range of boiling points and reactivities among them, separating hydrocarbons is a daunting challenge that usually requires low-temperature distillations or crude sieving techniques. Because hydrocarbons are so valuable they are usually found in mixtures and separating them is difficult. Therefore novel and efficient hydrocarbon separation techniques can translate into incalculable global energy and financial savings.

The most high-volume and high-value hydrocarbon separations are olefin/paraffin separations, xylene isomer separations, saturated alkane isomer separations, and methane purification. Short olefins are in constant high-demand as polyethylene and polypropylene feedstocks. Olefin and paraffin mixtures are produced at high temperatures from longer hydrocarbons. Either low temperature or high pressure separations are required to extract the valuable olefins component, making the process inefficient due to cooling or pressurization requirements.

Xylene isomer separations are similar to olefin/paraffin separations. Para-xylene is the most valuable among m- and o-xylenes and ethylbenzene because it is the most common polymer feedstock. Adsorptive separations are the most commonly used technique for this separation, where the cations in ion-exchanged zeolites are responsible for the selectivity among isomers.

Fuels such as gasoline and methane are equally viable routes for efficiency increases with new separation materials. The important octane number in gasoline varies tremendously among linear and branched C5 and C6 alkanes. In addition, carbonaceous materials such as agricultural, forest and municipal waste as well as natural gas, coal, oil shale and oil sands can be converted into combustible gases through thermochemical processing. Rather than burning biomass or fossil resources directly, gasification can be used to produce a mixture of carbon monoxide, hydrogen and methane known as synthesis gas (syngas). These thermochemical processes utilize conversion technologies such as gasification, reforming, pyrolysis, catalysis and other relevant processes for the conversion of fossil fuels (natural gas, coal, oil, oil shale, etc) and renewable biomass to syngas.

Synthesis gas comprises primarily carbon monoxide (CO) and hydrogen (H₂) and can come from many sources. Typical synthesis gas from gasified coal includes carbon monoxide, hydrogen and lesser amounts of carbon dioxide (CO₂) and other useful gases such as methane (CH₄) as well as small amounts of light paraffins, such as ethane and propane. Syngas may also contain gases such as nitrogen, argon, helium, oxygen-containing compounds and water in a gaseous state. Syngas can subsequently undergo the water-gas shift reaction to produce primarily hydrogen and carbon dioxide:

Steam-Methane Reformation: H₂O+CH₄→3H₂+CO

Water-gas shift: H₂O+CO→H₂+CO₂.

The separation of CO₂ from H₂ is important in the context of two distinct applications: (i) the capture of CO₂ emissions like those produced from coal gasification power plants, and (ii) the purification of hydrogen gas, which is synthesized on megaton scales annually. For example, CO₂/H₂ separation can be used to capture CO₂ from power plants in the context of coal gasification, where coal is converted into syngas (CO and H₂) which subsequently undergoes the water-gas shift reaction to generate CO₂ and H₂. The hydrogen is used to generate electricity after it is separated from CO₂, which can then be prevented from release into the atmosphere. This strategy, called pre-combustion CO₂ capture, is advantageous in comparison to other CO₂ capture technologies that require separation of CO₂ from N₂, O₂, or CH₄ because of the stark difference in size and polarizability between CO₂ and H₂.

As mentioned above, CO₂/H₂ separation is also relevant to hydrogen syntheses, which is primarily achieved by reforming natural gas to generate syngas and again utilizing the water-gas shift reaction to generate hydrogen. Approximately 50 million tons of H₂ are synthesized each year using this pair of reactions, and the separation of H₂ and CO₂ is most commonly accomplished using pressure-swing adsorption (PSA), where the gas product mixture is exposed under high pressure to solid adsorbents (a mixture of zeolites and activated carbons) that selectively adsorb CO₂, and then release CO₂ upon a pressure decrease or purge with hydrogen. PSA is advantageous in comparison to other separations techniques such as liquid absorbents, membrane or cryogenic separation due to the high purity and yield of hydrogen that can be produced.

Much of the energy input for a PSA system is used in the mass transport of the gas and regeneration of the adsorbents, and as a result improving adsorbent selectivity and capacity for CO₂ would increase efficiency. Extensive experimental and theoretical investigations suggest that further optimization of zeolites and activated carbons will yield only modest improvements in CO₂/H₂ separation performance. Thus, there is a need for new types of adsorbents with the potential for displaying significantly improved CO₂ capacity and selectivity.

Hydrogen is commonly generated by steam-reformation of methane. This process generates CO and H₂. Using this CO, the water-gas shift reaction generates CO₂ and more H₂. Some CO (ca. 1-3%) and CH₄ (ca. 3-6%) impurities remain in addition to the large fraction of CO₂ (ca. 15-25%). Because such a large proportion of the resulting gas mixture is CO₂, an ideal adsorbent will have a high capacity for CO₂. However, the separation of CH₄ from H₂ is equally or perhaps more important than CO₂/H₂ separation. This is because in a packed bed of porous adsorbent the least adsorbing impurity will elute first and contaminate the product stream. The adsorbent must be regenerated when an impurity starts to elute, and regeneration is a critical factor in optimizing an H₂ purification system. In an H₂ stream contaminated with CO₂, CH₄, and CO, CH₄ is the least adsorbing impurity, because it has no quadrupole or dipole moment. Methane is also important to remove from a flue gas, since it is a potent greenhouse gas.

The separation of CH₄ from H₂ is also relevant to refinery off-gas processing. The gas mixture that is being separated is approximately 50% H₂ at 5-10 bar. Here, the impurities are C1-C5 hydrocarbons. As in CO₂/CH₄/H₂ separation, the most difficult separation is the most important to optimize. Methane is the smallest of the impurities, making the van der Waals forces between it and the surface of a porous material the weakest. As a result, CH₄/H₂ separation is the most difficult separation to achieve in refinery off-gas separation.

Separation of CO₂ from CH₄ is a distinct separation from those described above. It is also relevant to the purification of natural gas, which can have up to 92% CO₂ impurity at its source. Removal of CO₂, which is most commonly accomplished using amines to reduce CO₂ levels to the required 2% maximum, is conducted at pressures between 20 bar and 70 bar. Carbon dioxide removal is required for approximately 25% of the natural gas reserves in the United States.

Another important type of separation is the O₂/N₂ separation of air. With over 100 million tons produced annually, O₂ is one of the most widely used commodity chemicals in the world. Its potential utility in processes associated with the reduction of carbon dioxide emissions from fossil fuel-burning power plants, however, means that the demand for pure O₂ could grow enormously. For example, when implementing pre-combustion CO₂ capture, pure O₂ is used for the gasification of coal, which produces the feedstock for the water-gas shift reaction used to produce CO₂ and H₂. In addition, oxyfuel combustion has received considerable attention for its potential utility as an alternative to post-combustion CO₂ capture. Here, pure O₂ is diluted to 0.21 bar with CO₂ and fed into a power plant for fuel combustion. Since N₂ is absent from the resulting flue gas, the requirement for post-combustion separation of CO₂ from N₂ is eliminated.

The separation of O₂ from air is currently carried out on a large scale using an energy-intensive cryogenic distillation process. Zeolites are also used for O₂/N₂ separation, both industrially and in portable medical devices. However, this process is inherently inefficient as the materials used adsorb N₂ over O₂ with poor selectivity. By employing materials that selectively adsorb O₂ and can operate near ambient temperatures, lower energy and capital costs could be realized.

Accordingly, there is a need for an efficient methods and materials for selectively separating constituent gases from a stream of gases that can be performed at lower temperatures and pressures than existing techniques. There is also a need for materials and methods that provide selective, reversible electron transfer reactions and associated functions such as catalysis, including oxidation as well as gas storage. The present invention satisfies these needs as well as others and is generally an improvement over the art.

### SUMMARY OF THE INVENTION

The present invention is directed to metal-organic framework materials and methods for use in a variety of gas separation and manipulation applications including the isolation of individual gases from a stream of combined gases, such as oxygen/nitrogen, carbon dioxide/hydrogen, methane/hydrogen, carbon dioxide/methane, carbon dioxide/nitrogen, paraffin/olefin, propane/propene, ethane/ethane, carbon monoxide/nitrogen, carbon monoxide/methane, carbon monoxide/hydrogen and nitric oxide/nitrous oxide separations. The frameworks may also be used for gas storage and may have catalytic functions such as oxidization.

Metal-organic frameworks are a group of porous crystalline materials formed of metal cations or clusters joined by multitopic organic linkers. By way of example, and not of limitation, the invention provides functional materials made from metal-organic framework adsorbents selected from the group: M₂(2,5-dioxido-1,4-benzenedicarboxylate) where (M=Mg, Mn, Fe, Co, Cu, Ni or Zn) (“M₂(dobdc)”). The preferred framework M₂(dobdc), is a metal-organic framework family featuring coordinatively-unsaturated metal centers, for separating gases. The use of these materials for (1) CO₂/H₂ and CO₂/CH₄/H₂ separations (2) olefin/paraffin separations (3) CO/H₂, CO/N₂, and CO/CH₄ and (4) the use of the redox-active Fe^{II} centers in Fe₂(dobdc) for gas separations based on selective, reversible (partial) electron transfer reactions represent a novel advance in the field.

In one embodiment, the Fe₂(dobdc) framework provides many redox-active Fe^{II} centers to permit a variety of gas separations. For example, a method is provided for separating a mixture stream including O₂ and N₂ that includes contacting a mixture stream comprising O₂ and N₂ with a material comprising Fe₂(dobdc) to obtain a stream richer in O₂ as compared to the mixture stream, and then obtain a stream richer in N₂ as compared to the mixture stream. In another embodiment, acetylene may stored in the framework by simply contacting acetylene with the Fe₂(dobdc) bed. Another embodiment provides a method for oxidizing a material by contacting the material with Fe₂(dobdc) framework bed.

A simple method of making Fe₂(dobdc) includes reacting FeCl₂ with H₄dobdc (dobdc=2,5-dioxido-1,4-benzenedicarboxylate) in a reaction mixture to produce Fe₂(dobdc). The reaction mixture may also include dimethylformamide (DMF) and methanol.

The present invention also provides a method and metal-organic framework materials that are particularly suited as adsorbents for hydrogen purification and pre-combustion carbon dioxide capture from a pressurized stream of mixed gases by pressure swing adsorption. The metal organic framework materials selectively adsorb carbon dioxide at high pressures (5-40 bar) in the presence of hydrogen and desorbs carbon dioxide upon a decrease of carbon dioxide pressure. Due to their high surface areas and low bulk densities, these materials demonstrate remarkable working capacities for sequestering carbon dioxide, making them ideal for use in large scale processing plants and a great improvement over current adsorbents. The successful implementation of these new adsorbents could both reduce the substantial energy cost of hydrogen purification and reduce or eliminate CO₂ emissions in the generation of electricity from coal or syngas.

A group of adsorbents for pressure swing adsorption (PSA) separation of CO₂ from H₂ or other gases is provided that offers significant capacity and selectivity over zeolites and activated carbons. Metal-organic frameworks are a group of porous crystalline materials formed of metal cations or clusters joined by multitopic organic linkers. The high surface area and low bulk densities of these materials provide large gravimetric and volumetric capacities for CO₂.

Five selected metal-organic frameworks exhibiting representative properties, namely high surface area, structural flexibility, or the presence of open metal cation sites, were tested for utility in the separation of CO₂ from H₂ via pressure swing adsorption. Single-component CO₂ and H₂ adsorption isotherms were measured at 313 K and pressures up to 40 bar for (i) Zn₄O(BTB)₂ (MOF-177, BTB³⁻=1,3,5-benzenetribenzoate); (ii) Be₁₂(OH)₁₂(BTB)₄ (Be-BTB); (iii) Co(BDP) (BDP²⁻=1,4-benzenedipyrazolate); (iv) H₃[(Cu₄Cl)₃(BTTri)₈] (Cu-BTTri, BTTri³⁻=1,3,5-benzenetristriazolate), and (v) Mg₂(dobdc) (dobdc⁴⁻=2,5-dioxido-1,4-benzenedicarboxylate).

These materials exhibit record internal surface areas and, as a result, a tremendous CO₂ storage capacity at the pressures relevant for a CO₂/H₂ separation (i.e. 5-40 bar). Further, the high adsorbent surface area enhances the selectivity for adsorption of CO₂ over H₂, since H₂ packs more efficiently than CO₂ due to its smaller size. Moreover, the ability to adjust the nature of the surfaces within these materials can be exploited to increase the strength of the interaction with CO₂.

The Ideal Adsorbed Solution Theory was also used to estimate realistic isotherms for the 80:20 and 60:40 H₂:CO₂ gas mixtures relevant to H₂ purification and pre-combustion CO₂ capture, respectively. In the former case, the results afford CO₂/H₂ selectivities between 5 and 450, and mixed-gas working capacities, assuming a 1 bar purge pressure, as high as 8.2 mol/kg and 7.5 mol/L. In particular it was discovered that, Mg₂(dobdc), a framework bearing surfaces with a high concentration of exposed Mg²⁺ cation sites, offers significant improvements over commonly used adsorbents. Because these materials are composed of multifunctional organic molecules linked by metal cations, a nearly limitless number of combinations are available to form new structures, resulting in an immense versatility in the possible geometries and surface properties. Ideally, a metal-organic framework could be synthesized specifically for application in any given gas separation.

According to one aspect of the invention, a porous adsorbent material is provided of the family M₂(2,5-dioxido-1,4-benzenedicarboxylate) where (M=Mg, Mn, Fe, Co, Cu, Ni or Zn) for separation of gases from a mixture of gases.

According to another aspect of the invention, a metal organic framework is provided that can have catalytic activity.

Yet another aspect of the invention is to provide a method for separating carbon dioxide and hydrogen and methane from a stream of gases.

Another aspect of the invention is to provide a metal-organic framework that is adaptable to many different separation needs.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

Further aspects of the invention will be brought out in the following portions of the specification, wherein the detailed description is for the purpose of fully disclosing preferred embodiments of the invention without placing limitations thereon.

FIG. 1 is a representation of a portion of the crystal structure of desolvated Fe₂(dobdc) as viewed approximately along the [001] direction.

FIG. 2 is a diffuse reflectance UV-visible-NIR spectra of methanol solvated (dotted line) and desolvated (solid line) Fe₂(dobdc) and H₄dobdc (dashed line).

FIG. 3 is a graph showing excess O₂ adsorption isotherms collected for Fe₂(dobdc) at 211, 226, 298 K and N2 adsorption at 298 K. Filled and open circles represent adsorption and desorption, respectively.

FIG. 4 is graph showing the uptake and release of O₂ in Fe₂(dobdc) over 13 cycles at 211 K. Adsorption occurred within 2 min upon application of 0.21 bar of O₂ and desorption was carried out by placing the sample under dynamic vacuum for 25 min.

FIG. 5 is a graph that shows calculated N₂ (diamonds) and O₂ (squares) breakthrough curves during adsorption of simulated air (O₂:N₂=0.21:0.79) by Fe₂(dobdc) at 211 K.

FIG. 6 is a Mössbauer spectra measured between 94 K and 252 K for Fe₂(dobdc) in the presence of O₂.

FIG. 7 shows an infrared spectra obtained for Fe₂(dobdc) in the absence of O₂ at room temperature (green) and upon dosing with 30 mbar of O₂ at room temperature and at a low temperature near 100 K. Difference spectra between the bare and O₂ dosed materials at low and room temperature are also shown.

FIG. 8A through FIG. 8D show first coordination spheres for the iron centers within Fe₂(dobdc) and its O₂ and N₂ dosed variants, as determined from Rietveld analysis of neutron powder diffraction data. The structures depicted are for samples under vacuum (FIG. 8A), dosed with N₂ at 100 K (FIG. 8B), dosed with O₂ at 100 K (FIG. 8C), and dosed with O₂ at 298 K (FIG. 8D). All diffraction data were collected below 10 K. Values in parentheses give the estimated standard deviation in the final digit of the number.

FIG. 9 is a graph showing the separation of a mixture of ethane and ethane.

FIG. 10 is a graph showing the separation of a mixture of propane and propene.

FIG. 11A through FIG. 11E depict plots of adsorbed amounts of pure CO₂ (triangles) and H₂ (circles) as a function of bulk gas pressure on MOF-177, Be-BTB, Co(BDP), Cu-BTTri and Mg₂(dobdc).

FIG. 12A and FIG. 12B depict the adsorption selectivity of CO₂ over H₂ as a function of bulk gas pressure on MOF-177, Be-BTB, Co(BDP), Cu-BTTri and Mg₂(dobdc) for an 80:20 and 60:40 H₂:CO₂ gas mixture, respectively.

FIG. 13A and FIG. 13B depict the gravimetric working capacity of CO₂ as a function of bulk gas pressure on MOF-177, Be-BTB, Co(BDP), Cu-BTTri and Mg₂(dobdc) for an 80:20 and 60:40 H₂:CO₂ gas mixture, respectively. These represent a purge pressure of 1 bar.

FIG. 14A and FIG. 14B depict the volumetric working capacity of CO₂ as a function of bulk gas pressure on MOF-177, Be-BTB, Co(BDP), Cu-BTTri and Mg₂(dobdc) for an 80:20 and 60:40 H₂:CO₂ gas mixture, respectively. These represent a purge pressure of 1 bar.

FIG. 15A and FIG. 15B depict Configurational-Bias Monte Carlo simulations. FIG. 15A shows absolute pure-component adsorption isotherms for CO₂ (triangles) and H₂ (circles) at 313 K in MOF-177. The lines are the dual-Langmuir-Freundlich fits of the pure component isotherms for CO₂ (solid) and H₂ (dashed).

FIG. 15B shows the component loadings in an 80:20 H₂:CO₂ mixture for CO₂ (triangles) and H₂ (circles) at 313 K in MOF-177 determined using CBMC simulations. The lines are the IAST estimations of the same mixture using the dual-Langmuir-Freundlich fits of the pure component isotherms for CO₂ (solid) and H₂ (dashed).

FIG. 16 is a graph depicting the adsorption selectivity of CO₂ and CH₄ over H₂ as a function of bulk gas pressure on Mg₂(dobdc) (closed symbols) and Zeolite 13X (open symbols) for an 80:20 H₂:CO₂ gas mixture.

FIG. 17 is a graph of IAST-calculated gravimetric working capacities for 313 K (circles) assuming a purge pressure of 1 bar for CO₂ and CH₄ in a 1:4:20 CH₄:CO₂:H₂ mixture in Mg₂(dobdc) (closed symbols) and Zeolite 13X (open symbols). The diamonds represent the predicted working capacity for a simulated breakthrough with a packed bed of adsorbent.

FIG. 18A through FIG. 18G are graphical representations of a portion of the solid state structure of Fe₂(dobdc).2C₂D₄ as determined by analysis of powder neutron diffraction data and the H₄(dobdc) ligand upon dosing Fe₂(dobdc) with acetylene, ethylene, ethane, propylene, and propane.

FIG. 19A and FIG. 19B are adsorption isotherms for methane, ethane, ethylene, and acetylene (FIG. 19A) and for propane and propylene (FIG. 19B) in Fe₂(dobdc) at 318 K; filled and open circles represent adsorption and desorption data, respectively. The adsorption capacities at 1 bar correspond to 0.77, 5.00, 6.02, 6.89, 5.67, and 6.66 mmol/g, respectively.

FIG. 19C and FIG. 19D are breakthrough curves for the adsorption of equimolar ethane/ethylene (FIG. 19C) and propane/propylene (FIG. 19D) mixtures flowing through a 1.5 mL bed of Fe₂(dobdc) at 318 K with a total gas flow of 2 mL/minute at atmospheric pressure.

FIG. 20A is a graph of the calculated methane, ethane, ethylene, and acetylene breakthrough curves for an equimolar mixture of the gases at 1 bar flowing through a fixed bed of Fe₂(dobdc) at 318 K.

FIG. 20B is a schematic representation of the separation of a mixture of methane, ethane, ethylene, and acetylene using just three packed beds of Fe₂(dobdc) in a vacuum swing adsorption or temperature swing adsorption process.

FIG. 21 depicts plots of adsorbed amounts of pure CO (squares) H₂ (circles), CH₄ (triangles), and N₂ (stars) as a function of bulk gas pressure on Fe₂(dobdc).

### DETAILED DESCRIPTION OF THE INVENTION

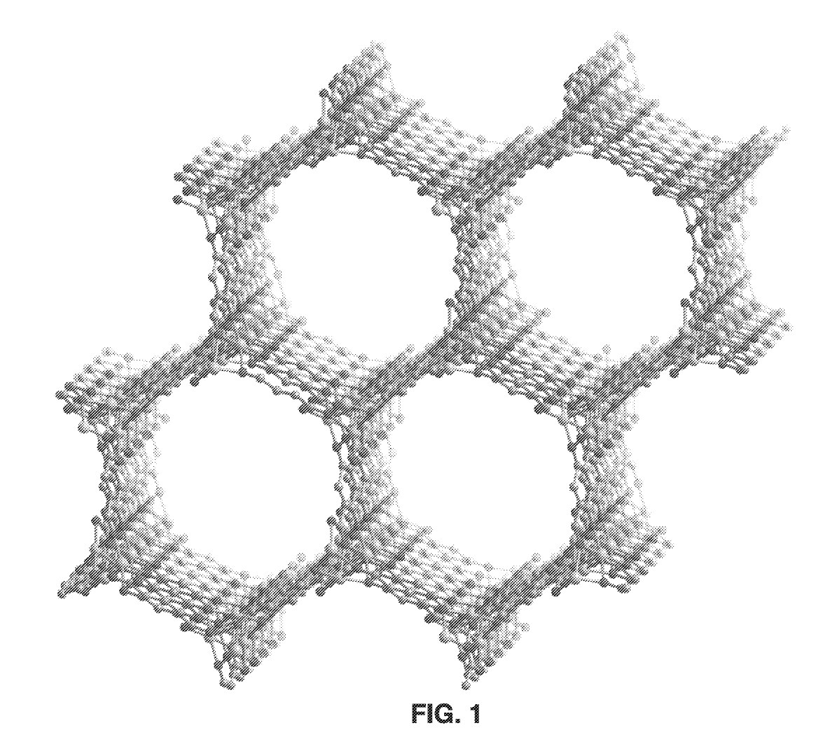

Referring more specifically to the drawings, for illustrative purposes several embodiments of the metal-organic framework adsorbents of the present invention are depicted generally in FIG. 1 through FIG. 21 and the associated methods for using and producing the frameworks. It will be appreciated that the methods may vary as to the specific steps and sequence and the metal-organic framework architecture may vary as to structural details, without departing from the basic concepts as disclosed herein. The method steps are merely exemplary of the order that these steps may occur. The steps may occur in any order that is desired, such that it still performs the goals of the claimed invention.

Turning now to FIG. 1, an embodiment of a portion of a metal-organic framework crystal structure of desolvated Fe₂(dobdc) as viewed approximately along the [001] direction is schematically shown. This is a representation of the structure of the group M₂(2,5-dioxido-1,4-benzenedicarboxylate) where (M=Mg, Mn, Fe, Co, Cu, Ni or Zn) that is used for separation of gases from a mixture of gases. These metal-organic frameworks are a group of porous crystalline materials formed of metal cations or clusters joined by multitopic organic linkers. The metal-organic frameworks are preferably particulates formed into a bed and may also be mixed with activated carbon to form a bed.

Two frameworks, Fe₂(dobdc) and Mg₂(dobdc), are used to illustrate the M₂(dobdc) family and the methods of use for gas separations. Fe₂(dobdc) has redox-active Fe^{II} centers for gas separations based on selective, reversible (partial) electron transfer reactions. Mg₂(dobdc) is a framework that is particularly suited for carbon dioxide/hydrogen/methane separations. It will be seen that the selection of the metal cations and organic framework structure can be tailored by the type of gases to be separated and the temperature and pressure conditions of the separation.

Generally, a method for separating constituent gases from stream of mixed gases containing a first chemical and a second chemical is provided with the use of an adsorbent of a metal-organic framework adsorbent of the group M₂(2,5-dioxido-1,4-benzenedicarboxylate) where M=Mg, Mn, Fe, Co, Cu, Ni or Zn. The stream of mixed gases is directed across a bed of adsorbent and the molecules of the first chemical are adsorbed onto the metal-organic framework so that the resulting stream is richer in the second chemical as compared to the mixture stream that is collected. The adsorbed first chemical is released from the metal-organic framework to obtain a stream richer in the first chemical as compared to the mixture stream that is also collected. The adsorbed chemical is typically released by a change in temperature or pressure. A purge gas may also be used to move the released gas through the bed for collection.

The Mg₂(dobdc) framework illustration can be used to separate carbon dioxide and carbon monoxide from other gases from a pressurized stream of gases such as H₂ and CH₄ at temperatures greater than room temperature, for example. Gas streams of carbon dioxide and hydrogen are typically provided in a stream under pressure ranging from approximately 5 bar to approximately 40 bar. The gas stream temperature is preferably maintained between approximately 300 K and approximately 320 K and the stream is introduced to a bed of at least one metal-organic framework carbon dioxide adsorbent and the gases of the pressurized mixed gas stream that are not adsorbed to the metal-organic carbon dioxide adsorbent are collected. The sequestered carbon dioxide or carbon monoxide is then released and collected.

Similarly, the Fe₂(dobdc) framework can separate gases at low pressures and temperatures with the same procedure. Not only can Fe₂(dobdc) be used to separate gases but it also be used to store gases such as acetylene for later release. The metal cation may also have specific activity that is maintained with the formation of the framework structure. For example the Fe₂(dobdc) framework can also act as a oxidation catalyst.

The invention may be better understood with reference to the accompanying examples, which are intended for purposes of illustration only and should not be construed as in any sense limiting the scope of the present invention as defined in the claims appended hereto.

### Example 1

In order to demonstrate the functionality of metal-organic frameworks featuring coordinatively-unsaturated metal centers for separating gases, members of the family M₂(dobdc) (M=Mg, Mn, Fe, Co, Mn, Cu, and Zn) were produced and tested. The first illustration was Fe₂(2,5-dioxido-1,4-benzenedicarboxylate) “Fe₂(dobdc)” that uses redox-active Fe^{II} centers in Fe₂(dobdc) for gas separations based on selective, reversible (partial) electron transfer reactions.

Fe₂(dobdc) was initially tested in the context of separating a mixture stream including O₂ and N₂ to obtain a stream richer in O₂ as compared to the mixture stream, and obtain a stream richer in N₂ as compared to the mixture stream.

Synthesis of Fe₂(dobdc) was performed with the reaction of anhydrous FeCl₂ with H₄ (2,5-dioxido-1,4-benzenedicarboxylate) “H₄dobdc” in a mixture of dimethylformamide (DMF) and methanol. The DMF and methanol afforded a solvated form of Fe₂(dobdc) as a red-orange microcrystalline powder. Powder x-ray diffraction data showed the compound to adopt the MOF-74 or CPO-27 structure type displayed in FIG. 1, as previously observed for M₂(dobdc) (M=Mg, Mn, Fe, Co, Cu, Ni, Zn). The compound rapidly changed color to dark brown upon exposure to air, presumably due to at least partial oxidation of the Fe^{II} centers by O₂. Based upon color, it is likely that the brown phase previously reported as Fe₂(dobdc) is actually some oxidized form of the compound. It was noted that, perhaps owing to their air-sensitive nature, only a very few metal-organic frameworks based upon iron(II) have yet been isolated.

The new framework was completely desolvated by soaking it in methanol to exchange coordinated DMF, followed by heating under dynamic vacuum at 433 K for 48 hours. The resulting solid was light green in color. Rietveld analysis of the powder neutron diffraction data collected for Fe₂(dobdc) indicate retention of the framework structure with no residual bound solvent. Thus, desolvation converted the Fe^{II} centers of the framework from an octahedral coordination geometry with one bound solvent molecule to a square pyramidal geometry with an open coordination site.

Low-pressure N₂ adsorption data obtained for Fe₂(dobdc) at 77 K revealed a type I adsorption isotherm characteristic of a microporous solid. The data indicate a BET surface area of 1360 m²/g (1535 m²/g Langmuir). This value is significantly higher than the 920 m²/g Langmuir surface area reported for the material prepared in the presence of air and is in close agreement with the BET surface areas of 1218 m²/g and 1341 m²/g reported for Ni₂(dobdc) and Co₂(dobdc), respectively, indicating full evacuation of solvent molecules from the pores of the material.

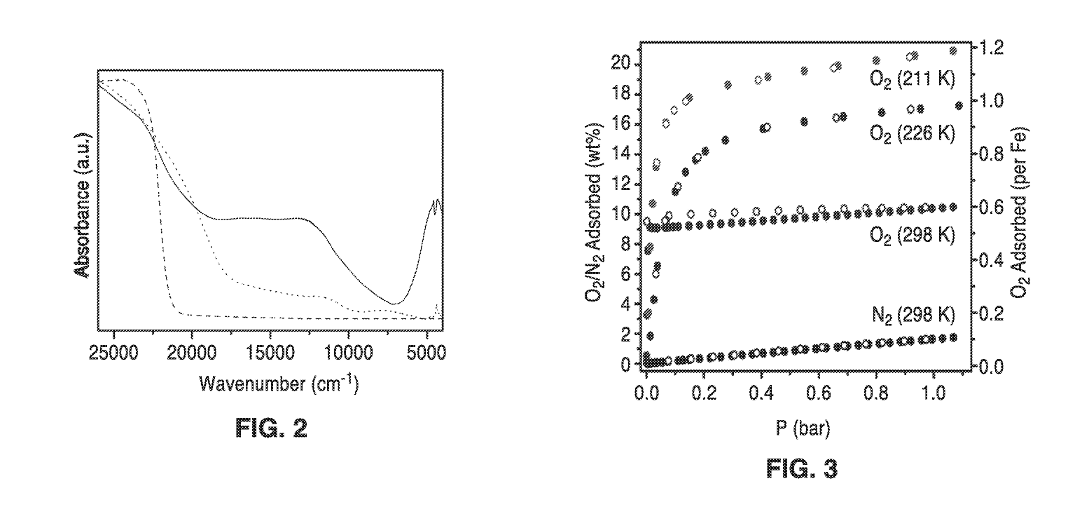

The UV-vis-NIR Spectroscopy of the electronic absorption spectra for Fe₂(dobdc).4MeOH, Fe₂(dobdc), and H₄dobdc is shown in FIG. 2. The spectrum for the yellow-ochre compound Fe₂(dobdc).4MeOH exhibited a low energy doublet with peaks at 11600 cm⁻¹ and 7600 cm⁻¹. High-spin FeII centers in an octahedral symmetry are expected to show a spin-allowed transition, ⁵E_{g}←⁵T_{2g}, in the near infrared region, and in many compounds this band is split into a doublet due to a lower symmetry ligand field, which lifts the two-fold orbital degeneracy of the ⁵E_{g} term. At higher energy, a broad component centered at 16000 cm⁻¹ and a strong band with a maximum around 21000 cm⁻¹ appear in the spectrum. The structure and position of these absorptions suggest they arise from mixing of d-d and charge transfer (LMCT and MLCT) transitions. Heating the solvated material at 433 K in a vacuum resulted in the removal of coordinated methanol with the formation of five-coordinative Fe^{II} centers. The corresponding change in symmetry at the metal site to approximately C₄ᵥ strongly affects the electronic transitions, which is evident from the spectrum of the desolvated material. In particular, the band at 21000 cm⁻¹ slightly shifts to lower energy, mixing with the component at 16000 cm⁻¹ and with the d-d transition, resulting in a strong absorption extending through 13000 cm⁻¹. The very strong absorption maximum at 4400 cm⁻¹ is associated with a d-d transition, with enhanced intensity owing to loss of an approximate inversion center in the ligand field upon conversion from pseudooctahedral to square pyramidal coordination.

O₂ and N₂ adsorption of the metal-organic framework Fe₂(dobdc) was then tested. Gas adsorption isotherms indicated that Fe₂(dobdc) preferentially binds O₂ over N₂ at all temperatures measured (201 K, 211 K, 215 K, 226 K, and 298 K). As shown in FIG. 3, the O₂ adsorption isotherm measured at 298 K is extremely steep, climbing to near 9.3 wt % at a pressure of just 0.01 bar. As the pressure is increased to 1.0 bar, uptake increases slightly to 10.4 wt %. The steep initial rise in the isotherm is consistent with strong binding of O₂ to some of the Fe^{II} centers, while the subsequent gradual increase in adsorption is likely due to O₂ physisorbed to the framework surface. Importantly, the amount of strongly bound O₂ corresponds to 0.5 molecules per iron center. Adsorption of N₂ under these conditions is noticeably lower, gradually rising to just 1.3 wt % at 1.0 bar. The selectivity factor of this material, calculated as the mass of O₂ adsorbed at 0.21 bar divided by the mass of N₂ adsorbed at 0.79 bar, is 7.5. Although this selectivity factor was among the highest reported for metal-organic frameworks, room temperature O₂ adsorption was found to be irreversible. Attempts to identify conditions to release coordinated O₂ by heating at temperatures of up to 473 K under dynamic vacuum ultimately lead to decomposition of the framework.

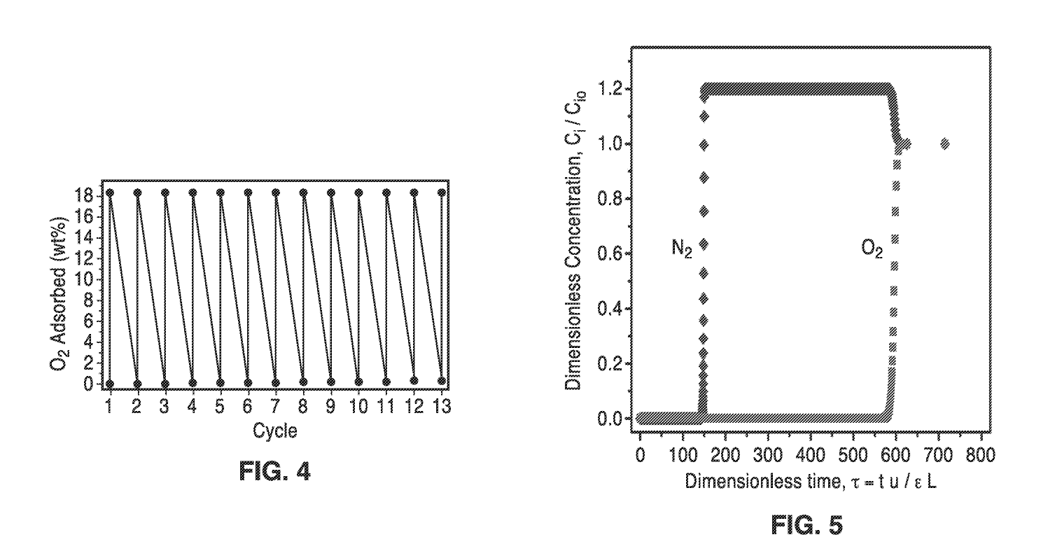

Upon dosing Fe₂(dobdc) with O₂ at lower temperatures, it was noted that the black color characteristic of the oxidized framework could be returned to light green by applying vacuum to the sample, suggesting reversible O₂ adsorption. Additional O₂ adsorption experiments confirmed this result. As shown in FIG. 3, at 226 K the framework adsorbs 14.1 wt % O₂ at 0.21 bar, or 0.82 O₂ molecules per iron site. Although adsorption at this temperature is largely reversible, O₂ uptake decreases to 11.9 wt % after four adsorption/desorption cycles. Lowering the adsorption temperature to 211 K results in an increased O₂ uptake of 18.2 wt %, corresponding to 1.0 molecules of O₂ per iron center. The amount of O₂ adsorbed at this temperature was found to decrease only slightly to 17.5 wt % after eight adsorption/desorption experiments. However, by cycling at a rapid rate, allowing just 2 minutes for adsorption and 25 minutes for desorption (instead of the 4-5 hours typically required for collecting a full isotherm), resulted in no noticeable loss in adsorption capacity after 13 cycles as seen in FIG. 4.

To predict how Fe₂(dobdc) would perform as an O₂/N₂ separation material, ideal adsorbed solution theory (IAST) was employed at temperatures for which O₂ adsorption is reversible. The O₂ and N₂ isotherms measured at 201, 211, 215, and 226 K were modeled with dual-site Langmuir-Freundlich fits. Isosteric heats of adsorption that were calculated from these fits were plotted in and indicated higher enthalpies for O₂ adsorption than N₂ adsorption over the entire pressure range measured. The higher propensity of O₂ to accept charge from FeII results in a larger initial isosteric heat of −41 kJ/mol, as compared to that of N₂ (−35 kJ/mol). Accordingly, Fe2(dobdc) displays a high O₂/N₂ selectivity at 201, 211, 215, and 226 K. The selectivity was observed to range from 4.4 to over 11 and reached a maximum of 11.4 at 201 K and about 0.4 bar.

The high O₂/N₂ selectivity in conjunction with the rapid and reversible cycling times, suggested that Fe₂(dobdc) warranted further consideration as an adsorbent for O₂/N₂ separations via a modified vacuum-swing adsorption (VSA) process. Here, dry air was flowed over a packed bed of Fe₂(dobdc) at temperatures near 210 K, which could potentially offer significant cost and energy savings over current separation technologies that are performed at much lower temperatures. Breakthrough experiments were simulated at 211 and 226 K to evaluate the performance of Fe₂(dobdc) for the separation of O₂ from N₂ at concentrations similar to those present in air (see FIG. 5). The x-axis seen in FIG. 5 is a dimensionless time, τ, obtained by dividing the actual time, t, by the contact time between the gas and metal-organic framework crystallites, εL/u. For a given adsorbent, under selected operating conditions, the breakthrough characteristics are uniquely defined by τ, allowing the results presented here to be equally applicable to laboratory scale equipment as well as to industrial scale adsorbers. It is apparent from the simulated curves that N₂ quickly saturates the sample, as evidenced by the low breakthrough time.

In contrast to currently employed VSA processes, in which N₂ is selectively adsorbed on the packed bed while O₂ is collected, the Fe₂(dobdc) framework selectively adsorbs O₂. Accordingly, shortly after N₂ breakthrough, the gas stream is pure nitrogen while O₂ is retained by the framework. Upon O₂ breakthrough, the VSA process is advanced to the second step, in which vacuum is applied to the sample bed. Although the gas at the outlet is initially a mixture of N₂ and O₂, the concentration of O₂ quickly increases to near 100 mole %. This results in a large supply of pure O₂. After a majority of the O₂ is removed from the adsorber, a low-pressure flow of pure N₂ would be flowed over the material to fully regenerate the bed for subsequent cycling.

Mössbauer Spectra was also taken for the framework material. The different O₂ adsorption behavior at low versus room temperature that was observed suggested the existence of two different modes by which O₂ binds to the open iron sites in Fe₂(dobdc). Mössbauer spectroscopy was employed to probe the electronic structure at the metal center. At all temperatures, the spectra of Fe₂(dobdc) in the absence of O₂ featured a simple doublet. At 298 K this doublet exhibited an isomer shift of 1.094(3) mm/s and a quadrupole splitting of 2.02(1) mm/s. These values are consistent with high-spin iron(II) in a square pyramidal coordination environment, as established below for the structure of the compound. Upon exposure to O₂, a small amount (ca. 5-15%, depending upon temperature) of high-spin iron(II) is still observed, presumably because a small portion of the iron(II) sites remain unoxygenated.

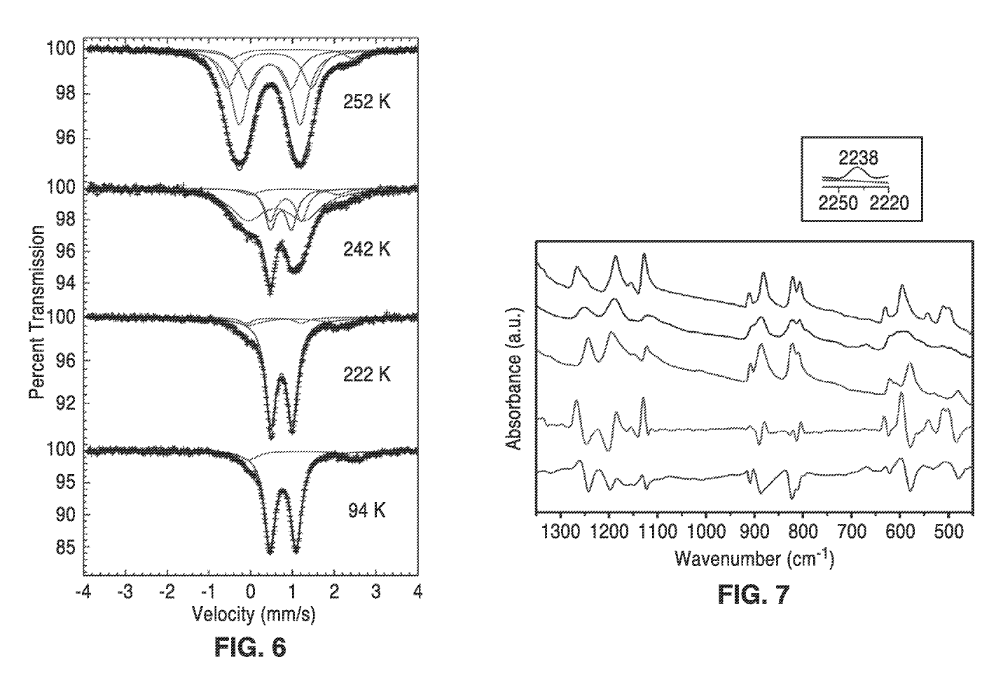

As shown in FIG. 6, the spectrum obtained in the presence of O₂ at 94 K indicates that almost all of the iron in the sample has a substantially reduced isomer shift that is approximately halfway between those expected for high-spin iron(II) and high-spin iron(III). This suggests a partial transfer of electron density from each of the Fe^{II} centers in the framework to form a weak bond with an O₂ species that is somewhere between the neutral molecule and superoxide. Thus, exposure of Fe₂(dobdc) to O₂ at low temperatures is consistent with the formation of Fe₂(O₂)₂(dobdc), featuring one weakly held O₂ molecule per iron atom. This is fully consistent with the observation of a reversible adsorption of 18.2 wt % O₂ at 211 K. At this point it is not possible to determine from the Mössbauer spectral results whether the electron transfer is static or dynamic, with an electron transfer time that is faster than the ca. 10⁻⁷ second time scale of the iron-57 Mössbauer spectral experiment.

Upon warming to 222 K and above, further changes arise in the Mössbauer spectra, which are clearly indicative of the formation of high-spin iron(III). The temperature at which this change in oxidation state occurs is consistent with the temperature at which we first observe the onset of and irreversible uptake of O₂ uptake in gas adsorption experiments (ca. 220 K). The change in oxidation state together with the irreversible uptake of 9 wt O2 suggest the formation of a compound of formula Fe₂(O₂)(dobdc), in which half of the Fe^{III} centers strongly bind a peroxide anion. Note that, consistent with the presence of at least two different coordination environments, one with O₂²⁻ bound and one without, fitting the spectra requires the use of at least two doublets for the iron(III) components.

The temperature dependence of the quadrupole splitting of main spectral components observed for the framework in the presence of O₂, corresponding to the Fe^{II} centers in Fe₂(dobdc), the Fe^{II/III} centers in Fe₂(O₂)₂(dobdc), and the Fe^{III} centers in Fe₂(O₂)(dobdc) was observed. As expected and in agreement with the Ingalls model, the quadrupole splitting of the square pyramidal high-spin Fe^{II} center in Fe₂(dobdc) decreases the most with increasing temperature, a decrease that results from changes in the electronic population of the 3d_{xy}, 3d_{xz}, and 3d_{yz} orbitals, whose degeneracy has been removed by the low-symmetry component of the crystal field.

Furthermore, there is a smaller decrease in the splitting upon warming of the other two components. The temperature dependence of the logarithm of the Mössbauer spectral absorption area of Fe₂(dobdc) fits well with the Debye model for a solid and yields a Debye temperature, θ_{D}, of 225(7) K, a value that is reasonable for the compound. Overall, the Mössbauer data point to a situation where, as a sample of Fe₂(dobdc) is warmed under O₂, an activation barrier is overcome for the transfer of electrons from two different iron centers to form a bound peroxide anion at every other iron site.

The presence of various Fe—O₂ adducts as a function of temperature should also be apparent by infrared spectroscopy. Spectra collected in transmission mode on thin films of Fe₂(dobdc) reveal a number of framework vibrations below 1300 cm⁻¹ as seen in FIG. 7. The reactivity of Fe₂(dobdc) towards O₂ was followed at both room temperature and near 100 K. The series of spectra were obtained at near 100 K with varying O₂ loadings. Oxygenation of Fe₂(dobdc) at low temperature gives rise to the spectrum in FIG. 7, and the most relevant changes are evident in the difference spectrum. New bands are seen at 1129, 541, and 511 cm⁻¹, while significant shifts are seen in the frameworks bands originally at 1250, 1198, and 580 cm⁻¹ (causing negative components in the difference spectrum). The component at 1129 cm⁻¹ is assigned to U(O—O) of a partially-reduced (near superoxo) O₂ species coordinated to Fe^{II/III} sites. The first overtone for this stretching mode is also clearly visible at 2238 cm⁻¹. The band at 541 cm⁻¹ is associated with the Fe—O₂ vibration of the of this species, whereas the band at 511 cm⁻¹ is attributed to an Fe—Oₗᵢₙₖₑᵣ mode of the framework, reflecting the O₂ adsorption induced modification in Fe—Oₗᵢₙₖₑᵣ bonds. The interaction with O₂ at low temperature is completely reversible by applying vacuum to the sample cell.

Oxygenation of Fe₂(dobdc) at room temperature gives rise to the black spectrum depicted in FIG. 7, which can be explained in terms of the formation of a peroxo species coordinated to Fe^{III} centers. The main features in this case are a peak at 790 cm⁻¹, due to a ν(O—O) vibrational mode, and a pair of peaks at 697 and 670 cm⁻¹, arising from the peroxo ring modes of the Fe-(η²-O₂) unit. The peaks at 550 cm⁻¹ and 507 cm⁻¹ are further assigned to the ν_{asym} and ν_{sym} modes of the iron-oxygen bond of the peroxo species. Similar features were more clearly visible in the ATR spectrum of an oxidized sample. Small changes were also visible in the Raman spectrum of the sample upon O₂ interaction. Overall, the vibrational spectra are fully consistent with the model already developed from interpretation of the O₂ adsorption data and Mössbauer spectra.

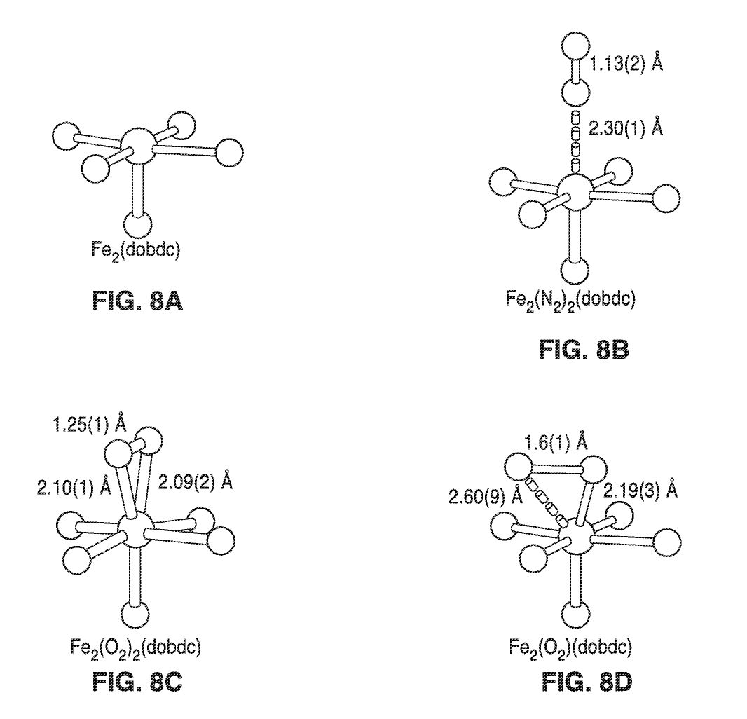

Structures were also evaluated via Neutron Powder Diffraction. Powder neutron diffraction data provide direct structural details of the means by which O₂ and N₂ interact with the Fe₂(dobdc) framework. As seen in FIG. 8, the initial data collected on an evacuated sample of Fe₂(dobdc) confirmed the presence of accessible Fe^{II} sites with a square pyramidal coordination environment. Here, each iron center is coordinated by O donor atoms from two aryloxide units (located at the front right and back left basal positions) and three carboxylate groups (at the remaining positions) from surrounding dobdc⁴⁻ ligands. Note that the arrangement of framework O donor atoms is the same in each depiction shown in FIG. 8.

A Rietveld refinement was performed against data collected for a sample of Fe₂(dobdc) that was cooled to 100 K, dosed with two equivalents of O₂ per iron, and then cooled to 4 K. Three different O₂ adsorption sites are evident in the resulting model. The highest occupancy site, with a refined occupancy of 0.917(8) O₂ molecules per iron, is located at the open iron coordination position. Significantly, the O₂ molecule binds in a symmetric side-on coordination mode, with Fe-0 distances of 2.09(2) and 2.10(1) Å. The O—O separation of 1.25(1) Å lies between the internuclear distances observed for free O₂ (1.2071(1) Å) and typical of an O²⁻ superoxide unit (1.28 Å). This again is consistent with only partial reduction of O₂ under these conditions. Although symmetric side-on coordination of superoxide and peroxide to other transition metals has been reported this represents, to the best of our knowledge, the first crystallographic evidence of non-bridging side-on binding of any dioxygen species to iron in a non-enzyme system. The second and third O₂ adsorption sites, with occupancies of 0.857(9) and 0.194(8), respectively, occur in the pores of the framework at distances of greater than 3 Å from the iron center and organic linker indicating weak dispersive type interactions between the adsorbate and the framework walls.

Rietveld refinement performed against data collected on a sample of Fe₂(dobdc) that had been dosed with an excess of O₂ at room temperature, evacuated, and subsequently cooled to 4 K was also performed. The data were best fit by a model in which O₂ is coordinated to iron in an asymmetric side-on mode and at a refined occupancy of 0.46(2). The model indicates substantial elongation of the O—O distance to 1.6(1) Å, consistent with a two-electron reduction of O₂ to peroxide. With an Fe—O₂ centroid distance of 2.26(1) Å, the peroxide unit also appears to have slipped substantially towards one of the bridging ligands. This type of coordination of peroxide has been observed previously in naphthalene dioxygenase and has also been proposed based upon spectroscopic evidence for a number of non-heme iron complexes.

Neutron powder diffraction data were further collected on a sample of Fe₂(dobdc) dosed with 0.5, 1.0, and 2.0 equiv of N₂ dosed at 80 K. Upon dosing with approximately 0.5 equiv of N₂, a binding site at the metal center is apparent with an occupancy of 0.641(5). Nitrogen coordinates end on with an Fe—N—N angle of 179(1)° and an Fe—N distance of 2.30(1) Å. The N—N distance of 1.133(15) Å is slightly longer than the N—N distance of free nitrogen (1.0977(1) Å). Additional N₂ uptake reveals a second site that runs more parallel to the pore walls, with N . . . O contacts between 3.4 and 3.6 Å. The close N₂-framework interactions are the origins of the relatively high enthalpy for adsorption. The metal-specific interactions, however, are clearly much weaker than for O₂, which results in interaction of both atoms with the metal, electron transfer, and a significant compression of the unit cell upon adsorption.

The differences in how O₂ binds to iron within Fe₂(dobdc) at low versus high temperatures suggests that the framework undergoes electron transfer processes similar to those reported for non-heme iron-containing enzymes. In these systems, O₂ typically progresses through a number of electron transfer steps starting with superoxo and peroxo. In the case of Fe₂(dobdc) at low temperature, each iron shares one of its electrons with a single O₂ molecule, resulting in oxidation of all of the metal centers to an intermediate iron(II/III) oxidation state. This charge transfer is reversible at low temperatures and accounts for the high gas uptake demonstrated in the gas adsorption experiments. However, at elevated temperatures two electrons are transferred to the adsorbing O₂ molecule, the first presumably being shared in a manner analogous to what occurs at low temperature and the second subsequently arriving from an adjacent iron center by promotion over an activation barrier via the available thermal energy. In this scenario, all of the metal centers within the framework are converted to iron(III), half of which are coordinated irreversibly to a peroxide anion, while the other half remain five-coordinate.

The foregoing results demonstrate the ability of Fe₂(dobdc), a new microporous metal-organic framework with open iron(II) coordination sites, to selectively bind O₂ over N₂ via electron transfer interactions. Breakthrough curves calculated using single-component gas adsorption isotherms and ideal adsorbed solution theory indicate that the material should be capable of the high-capacity separation of O₂ from air at temperatures as high as 226 K. This is substantially higher than the cryogenic temperatures currently used to separate O₂ from air on a large scale. At still greater temperatures, a thermal activation barrier to the formation of iron(III)-peroxide species is overcome and desorption of O₂ was no longer possible. Synthesis of related metal-organic frameworks with an increased activation barrier for the formation of peroxide will generate a high-capacity O₂ separation material that can operate closer to ambient temperatures.

In addition, the efficacy of the new redox-active framework in performing a variety of other gas separations where charge transfer can lead to selectivity. Additional example separations include, but are not limited to, paraffin/olefin separations, and nitric oxide/nitrous oxide separations.

### Example 2

The clear ability of Fe₂(dobdc) to activate O₂ can be exploited so that Fe₂(dobdc) can be employed as a catalyst for the oxidation of hydrocarbons, for example. The Fe₂(dobdc) framework reacts rapidly in air to produce either Fe₂(O₂)₂(dobdc) (low temperature) or Fe₂(O₂)(dobdc) (room temperature), both of which contain reactive oxygen, either as superoxide in the former or peroxide in the latter. The large pore volume, high surface areas, accessible metal centers, and thermally stable nature of both of these resulting materials make them very useful as oxidation catalysts. These catalysts can work with a number of systems, including the oxidation of methane to methanol and the oxidation of ethane/ethene and propane/propene. One illustration was the oxidation of propylene to acetone using O₂ as the oxidant.

The Fe₂(dobdc) framework catalyzes the oxidation of propylene to acetone with air as the oxidant. Although the yield of the reaction under current conditions is low the selectivity is approximately 100%.

### Example 3

To further demonstrate the broad functionality of the metal-organic framework family M₂(dobdc) (M=Mg, Mn, Fe, Co, Mn, Cu, and Zn), the Fe₂(dobdc) framework was used for the separation of hydrocarbon gases including olefin/paraffin separations.

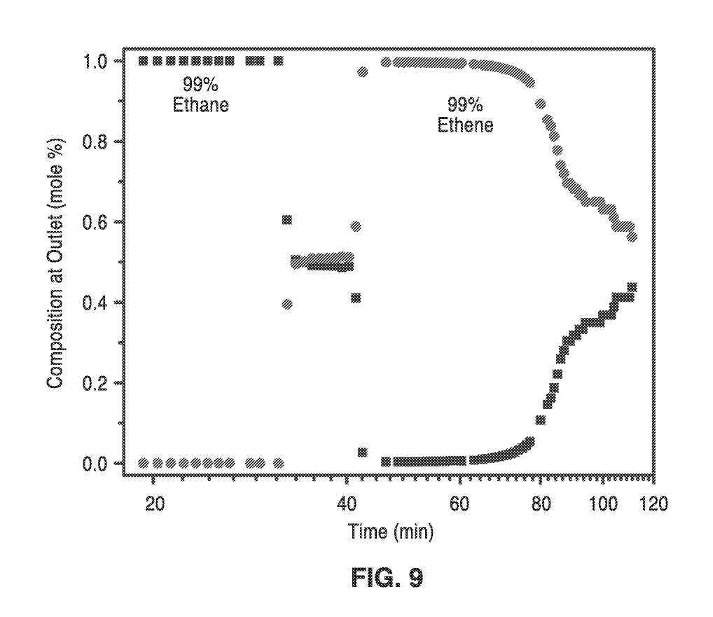

The metal-organic framework Fe₂(dobdc), featuring channels lined with a high concentration of soft Fe²⁺ cation sites, was shown to exhibit excellent performance characteristics for the separation of ethylene/ethane and propylene/propane mixtures. FIG. 9 is a graph showing the separation of a mixture of ethane and ethene. A 50/50 mixture of ethane and ethene is flowed through Fe₂(dobdc) at 318 K. The framework adsorbs ethene first, supplying greater than 99.5% purity ethane. After ethene “breaks through” gas feed is turned off to supply greater than 99% purity ethene.

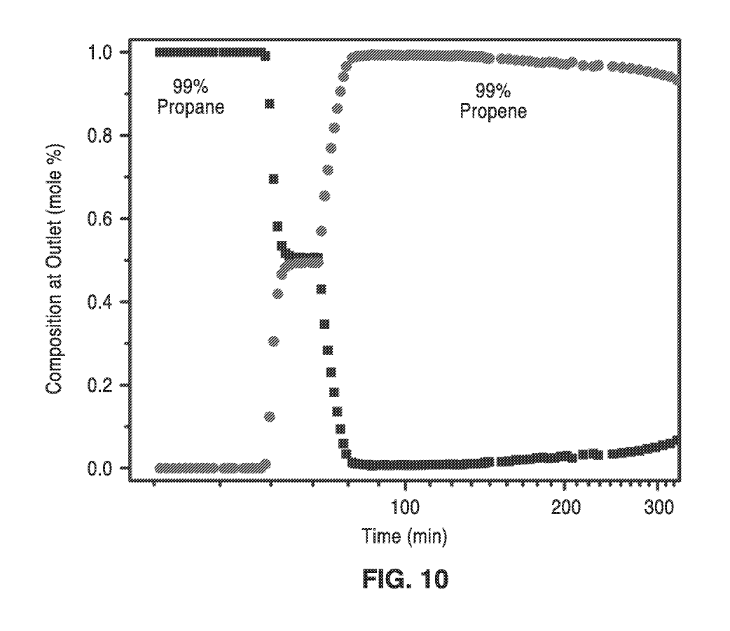

FIG. 10 is a graph showing the separation of a mixture of propane and propene. A 50/50 Mixture of propane and propene was flowed through Fe₂(dobdc) framework at 318 K. The framework adsorbs propene first, supplying greater than 99.5% purity propane. After propene “breaks through,” the gas feed was turned off to supply greater than 99% purity propene.

The breakthrough data obtained for the mixtures of ethane and ethene and propane and propene provide experimental validation of simulations, which are then used to show that the material can be expected to exhibit higher selectivities and capacities compared to other known adsorbents including the fractionation of ethane/ethane/ethylene/acetylene mixtures, removing acetylene impurities from ethylene, and membrane-based olefin/paraffin separations.

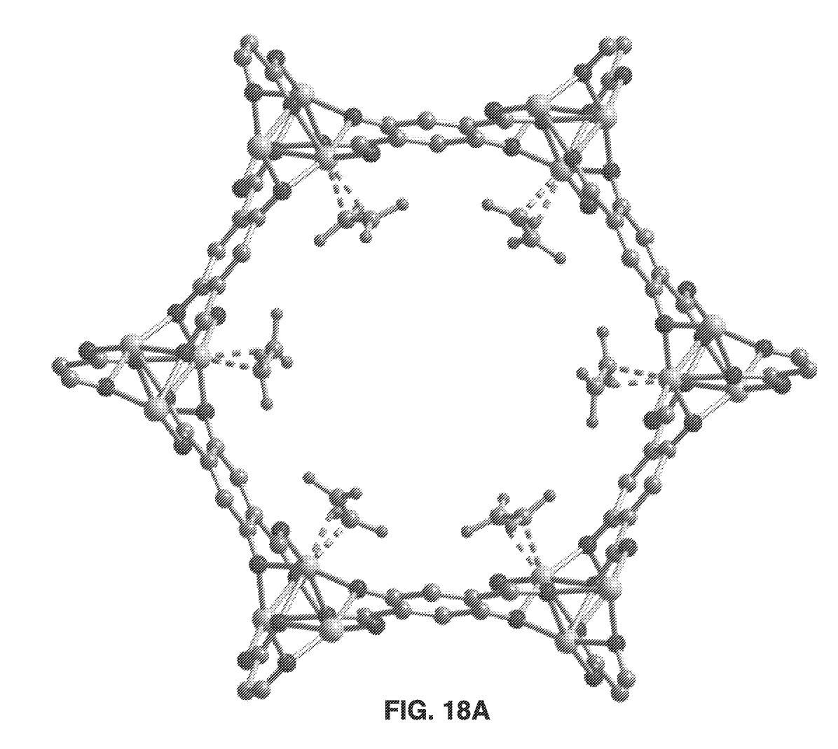

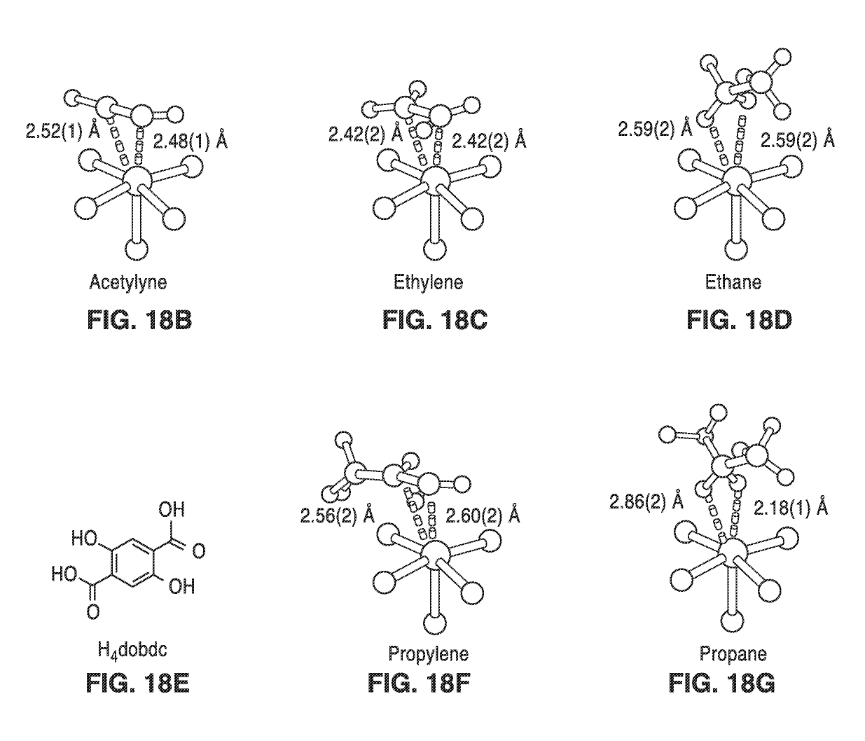

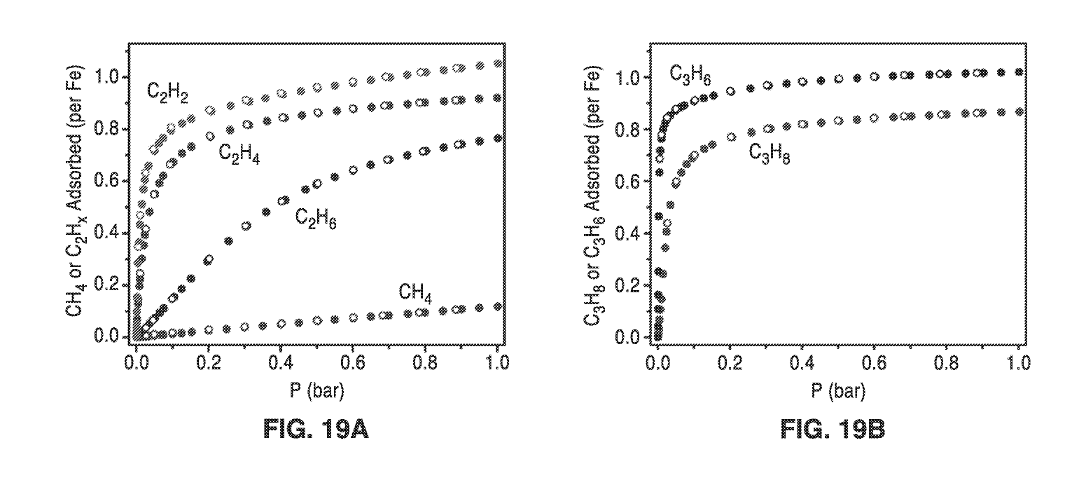

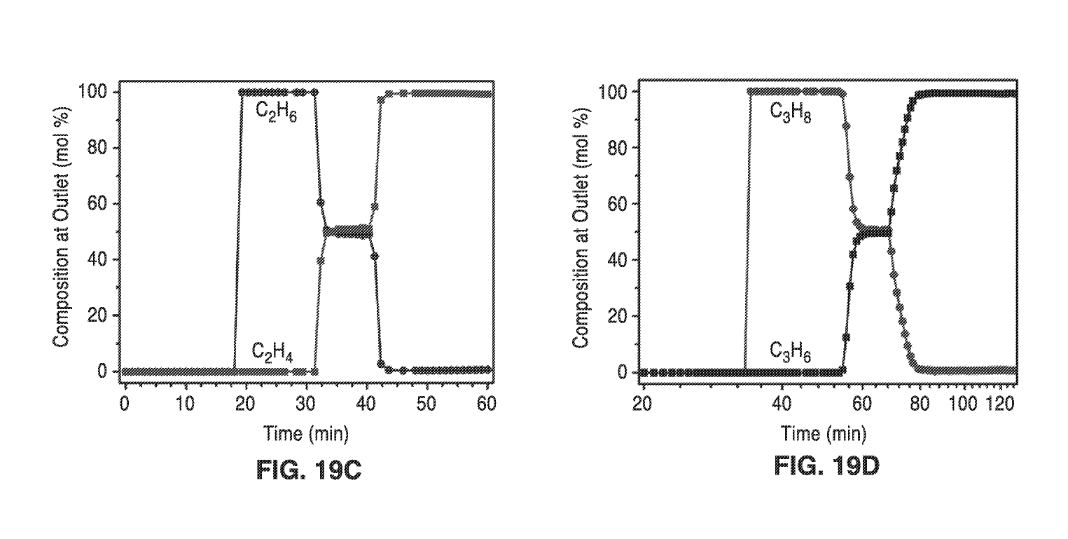

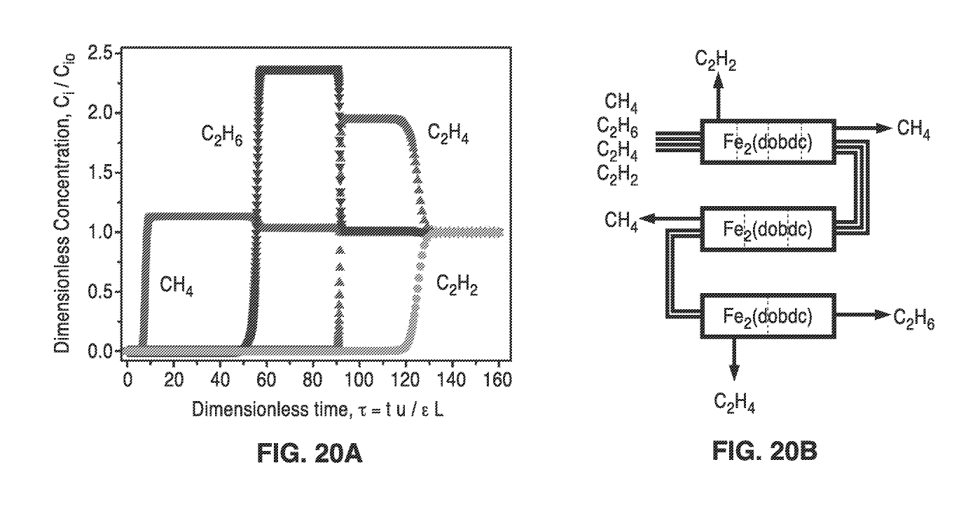

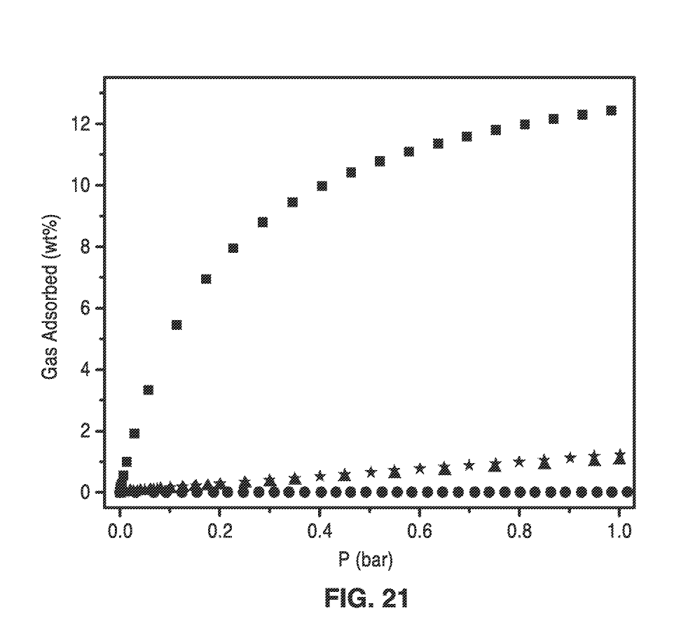

Neutron powder diffraction data also confirm a side-on coordination of acetylene, ethylene, and propylene at the iron(II) centers, while also providing solid-state structural characterization of the much weaker interactions of ethane and propane with the metal. Additionally, FIG. 18, FIG. 19, FIG. 20 and FIG. 21 demonstrate the separation of short hydrocarbons in Fe₂(dobdc).

FIG. 18 is a graphical representation of a portion of the solid state structure of Fe₂(dobdc).2C₂D₄ as determined by analysis of powder neutron diffraction data. The view is along the [001] direction, and shows an ethylene molecule bound to the open coordination site at each iron(II) center. The figures below are the H₄(dobdc) ligand and the first coordination spheres for the iron centers in the solid state structures obtained upon dosing Fe₂(dobdc) with acetylene, ethylene, ethane, propylene, and propane. It can be seen that for propane in the Fe₂(dobdc) framework the adsorbed hydrocarbon molecule has orientational disorder with respect to the open metal center. Of several refined models, the single-molecule with large displacement parameters is the most reasonable.

FIG. 19 at the top depicts gas adsorption isotherms for methane, ethane, ethylene, and acetylene (a) and for propane and propylene (b) in the Fe₂(dobdc) framework at 318 K. The filled and open circles represent adsorption and desorption data, respectively. The adsorption capacities at 1 bar correspond to 0.77, 5.00, 6.02, 6.89, 5.67, and 6.66 mmol/g, respectively. The bottom graph depicts the experimental breakthrough curves for the adsorption of equimolar ethane/ethylene (c) and propane/propylene (d) mixtures flowing through a 1.5 mL bed of Fe₂(dobdc) at 318 K with a total gas flow of 2 mL/minute at atmospheric pressure. After breakthrough of the olefin and return to an equimolar mixture composition, a nitrogen purge was applied, leading to desorption of the olefin. Note that in an actual separation scenario, desorption would instead be carried out by applying a vacuum and/or raising the temperature.

FIG. 20 on the left is a graph of the calculated methane, ethane, ethylene, and acetylene breakthrough curves for an equimolar mixture of the gases at 1 bar flowing through a fixed bed of Fe₂(dobdc) at 318 K. On the right is a schematic representation of the separation of a mixture of methane, ethane, ethylene, and acetylene using just three packed beds of Fe₂(dobdc) in a vacuum swing adsorption or temperature swing adsorption process.

FIG. 21 is a graph that plots the adsorbed amounts of pure CO (squares) H₂ (circles), CH₄ (triangles), and N₂ (stars) as a function of bulk gas pressure on the Fe₂(dobdc) framework.

### Example 4

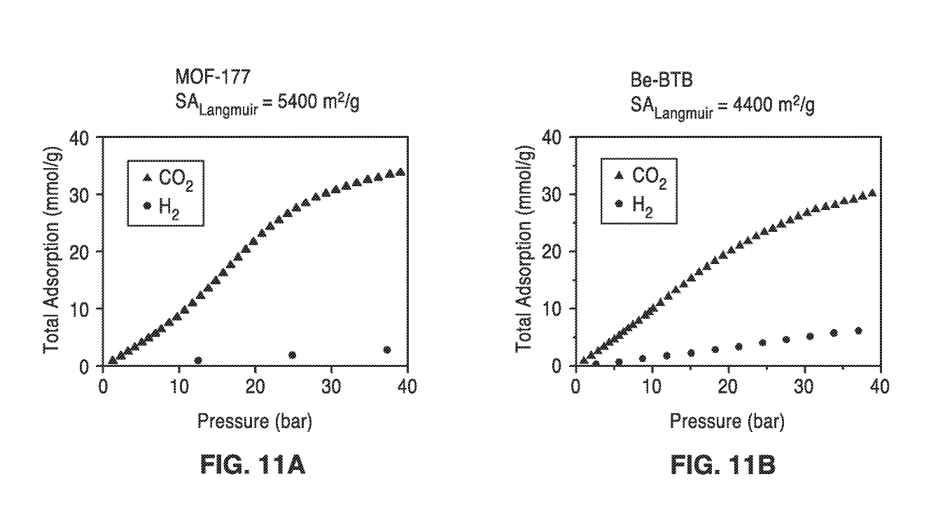

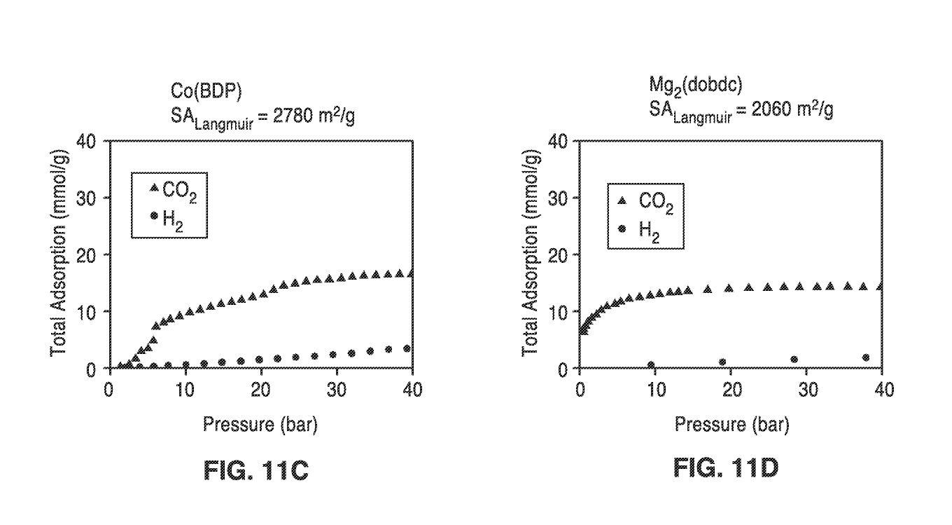

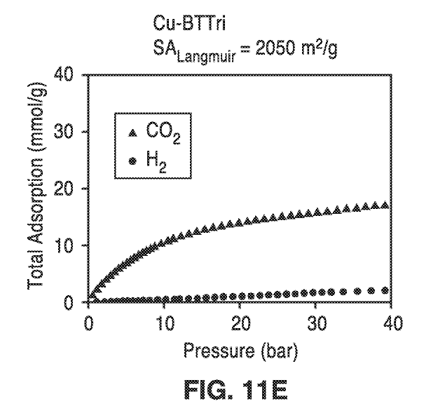

Metal-organic frameworks of the invention are particularly suited for separation of carbon dioxide from gas streams at both low or high pressures and moderate temperatures. To demonstrate, pure component H₂ and CO₂ isotherms up to 40 bar at 313 K were recorded on a representative variety of metal-organic frameworks using a volumetric Sieverts-type gas sorption analyzer in order to compare them with the performance of Mg₂(dobdc). The compounds Zn₄O(BTB)₂ (MOF-177, BTB³⁻=1,3,5-benzenetribenzoate) and Be₁₂(OH)₁₂(BTB)₄ (Be-BTB) were chosen as representative of metal-organic frameworks exhibiting a high surface area and a rigid framework structure. As a flexible framework, Co(BDP) (BDP²⁻=1,4-benzenedipyrazolate) was selected because of its high surface area relative to most compounds of this type. Finally, H₃[(Cu₄Cl)₃(BTTri)₈] (Cu-BTTri, BTTri³⁻=1,3,5-benzenetristriazolate) and Mg₂(dobdc) (dobdc⁴⁻=2,5-dioxido-1,4-benzenedicarboxylate) were chosen as prototypical of two broad classes of metal-organic frameworks that possess surfaces coated with exposed metal cations. All five compounds were synthesized and activated, and their Langmuir surface areas (see FIG. 11) were determined from N₂ adsorption isotherms collected at 77 K.

Mg₂(dobdc) was synthesized and activated. The yellow microcrystalline material was combined and washed repeatedly with DMF and soaked in DMF for 24 hours. The DMF was decanted, and freshly distilled methanol was added. The solid was then transferred to a nitrogen-filled glovebox. The methanol was decanted and the solid was soaked in DMF on a hotplate set at 100° C. for 18 hours. The DMF was decanted and replaced, and the solid was soaked at 100° C. for 4 hours. The DMF was decanted and replaced by methanol, which was decanted and replenished 6 times with a minimum of 6 hours between washes. In these syntheses, all other reagents were obtained from commercial vendors and used without further purification. Powder X-ray diffraction patterns were obtained on a Bruker D8 Advance diffractometer with a Cu anode (λ=1.5406 Å). Infrared spectra were obtained on a Perkin-Elmer Spectrum 100 Optica FTIR spectrometer furnished with an attenuated total reflectance accessory (ATR).

FIG. 11 shows CO₂ and H₂ isotherms for MOF-177, Be-BTB, Co(BDP), Cu-BTTri, and Mg₂(dobdc), where triangles represent CO₂ adsorption and circles represent H₂ adsorption. As can be seen, the CO₂ adsorption capacity scales roughly with surface area, and is much higher than the corresponding adsorption capacity for H₂ due to the higher polarizability and quadrupole moment of the CO₂ molecule. Notably, Cu-BTTri and Mg₂(dobdc) exhibit high CO₂ adsorption (particularly at low pressures) relative to their surface areas due to the additional polarizing influence of the open metal cation sites decorating the framework surfaces. Contrasting with these results, the step-like features in the CO₂ isotherm for Co(BDP) are likely associated with a gate-opening phenomenon arising from the flexibility of the framework structure.

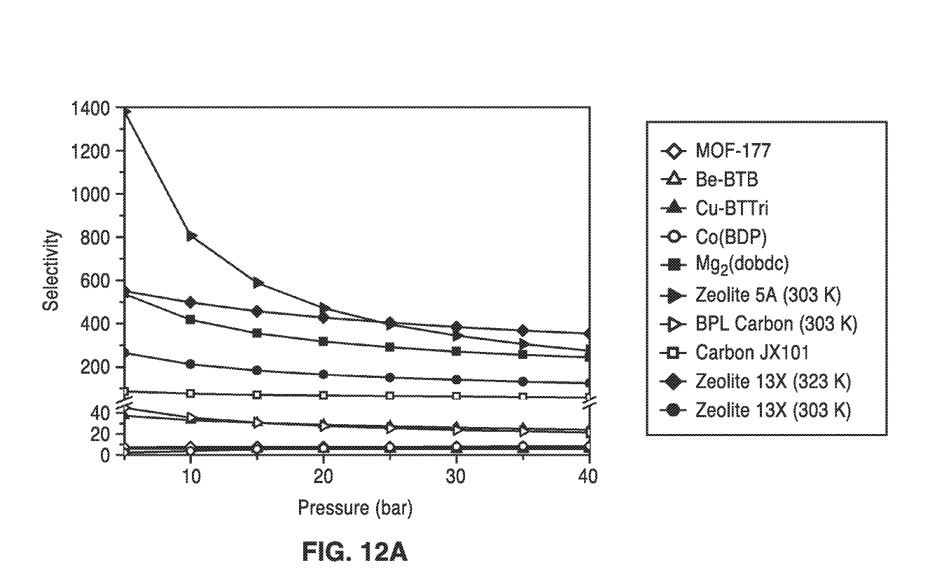

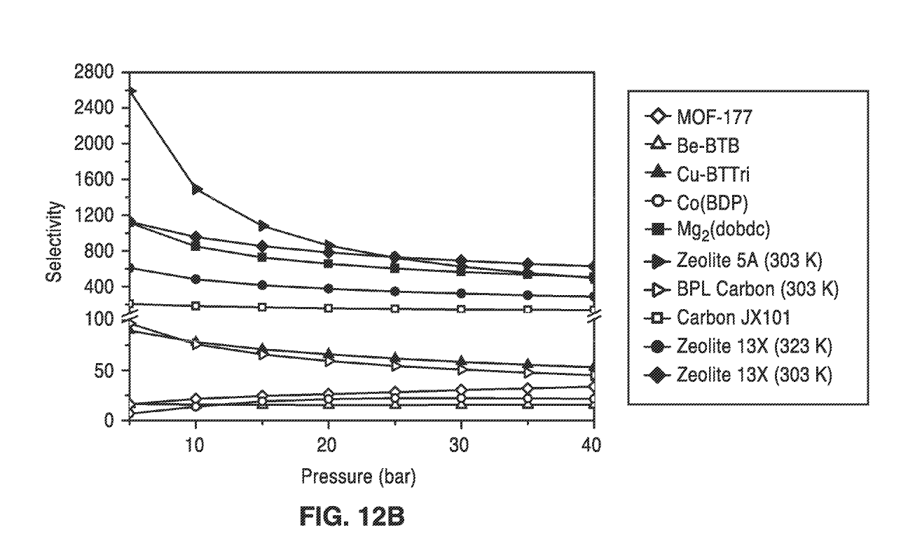

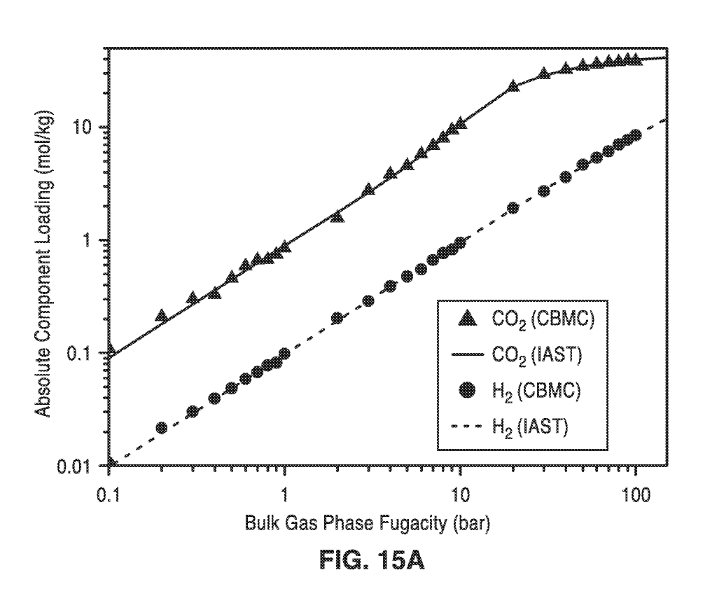

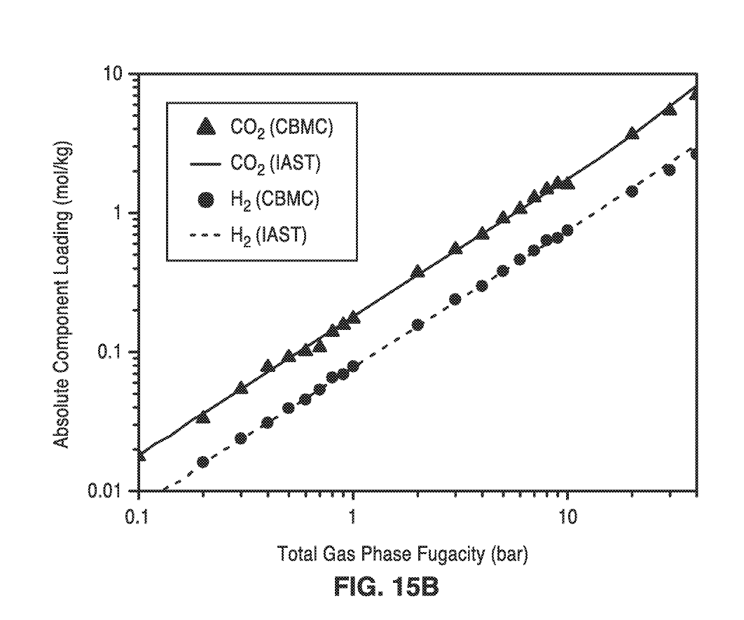

Ideal adsorbed solution theory (IAST) was applied to these data in order to estimate realistic adsorption isotherms for the 80:20 and 60:40 H₂:CO₂ gas mixtures relevant to H₂ purification and pre-combustion CO₂ capture, respectively. Evidence of the validity of its use for estimation of CO₂/H₂ equilibria in MOF's is presented in FIG. 15A and FIG. 15B. FIG. 12A and FIG. 12B, respectively, show the selectivity values obtained for 80:20 and 60:40 H₂:CO₂ mixtures for the five metal-organic frameworks studied along with two common activated carbons and zeolites 13X and 5A, both exceptionally selective with a high CO₂ capacity as well.

As can be seen in FIG. 12A and FIG. 12B, the two frameworks with exposed metal cation sites, Cu-BTTri and Mg₂(dobdc), display by far the highest selectivities, presumably owing to the greater polarizability of CO₂ versus H₂. With a greater concentration of cationic sites exposed on its surface, Mg₂(dobdc) shows the best performance, exhibiting a selectivity that gradually decreases from 538 at 5 bar to 244 at 40 bar.

Due to the nature of PSA purification, the working capacity, that is the difference between the capacity at the high intake pressure and at the lower purge pressure, is one metric for evaluating adsorbent candidates. The CO₂ working capacities for the metal-organic frameworks under an 80:20 H₂:CO₂ mixture and assuming a purge pressure of 1 bar were calculated using IAST and compared to the values obtained for the zeolites and activated carbons. While gravimetric capacities (moles of CO₂ adsorbed per kg of adsorbent) are normally reported when evaluating materials for a CO₂/H₂ separation, the volumetric working capacities (moles of CO₂ adsorbed per L of adsorbent) were also calculated, since both factors are critical in designing a PSA separation process. Here, the true advantage of utilizing metal-organic frameworks becomes apparent.

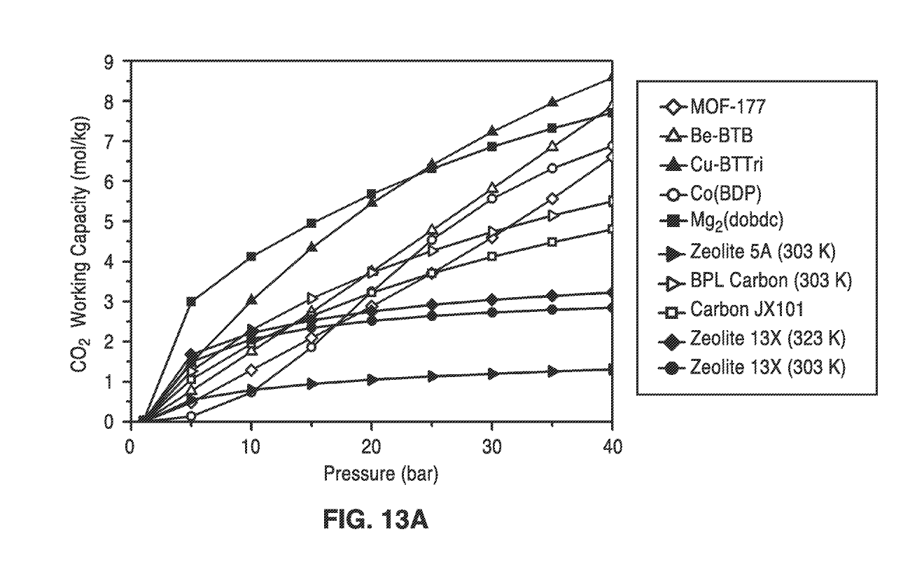

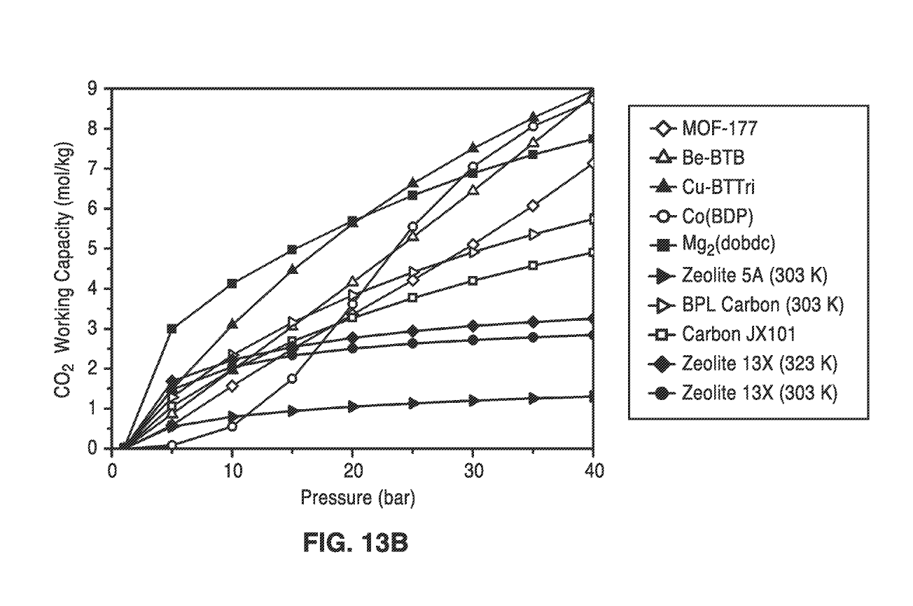

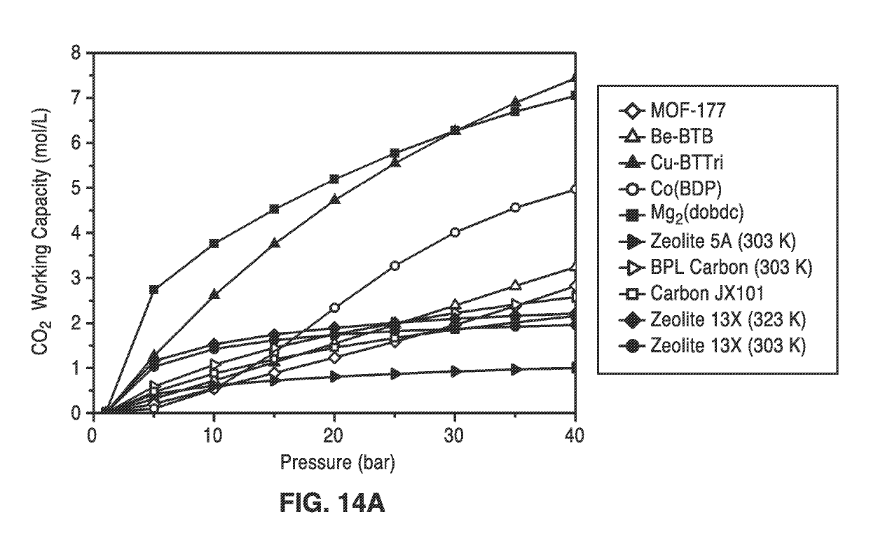

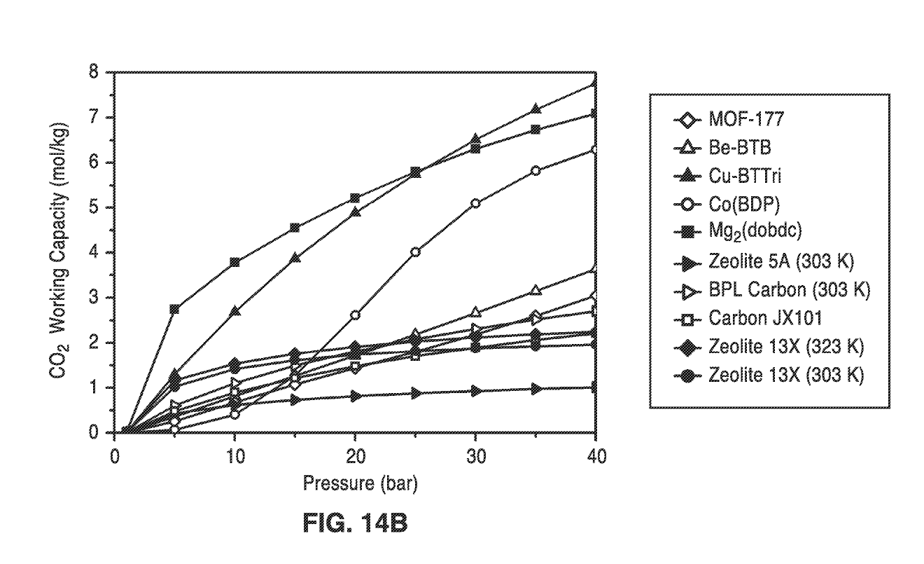

Gravimetric working capacities are shown in FIG. 13A and FIG. 13B and volumetric working capacities are shown in FIG. 14A and FIG. 14B, where FIG. 3A and FIG. 4A represent an 80:20 H₂:CO₂ mixture and FIG. 13B and FIG. 14B represent a 60:40 H₂:CO₂ mixture. Owing to its greater specific surface area and larger pore sizes, Mg₂(dobdc) outperforms the zeolites by a considerable margin, with working capacities climbing to values of 7.8 mol/kg and 7.1 mol/L at 40 bar. Thus, at higher pressures, use of Mg₂(dobdc) in place of zeolite 13X could reduce the mass of adsorbent needed by a factor of 2.4 and the volume needed by a factor of 3.2. For a 60:40 H₂:CO₂ mixture, the working capacities of metal-organic frameworks offer similar benefits. Here, however, due to the higher partial pressure of CO₂, the relative steepness of the CO₂ isotherm for Mg₂(dobdc) is less of an advantage, resulting in working capacities that are very comparable to those of Cu-BTTri.

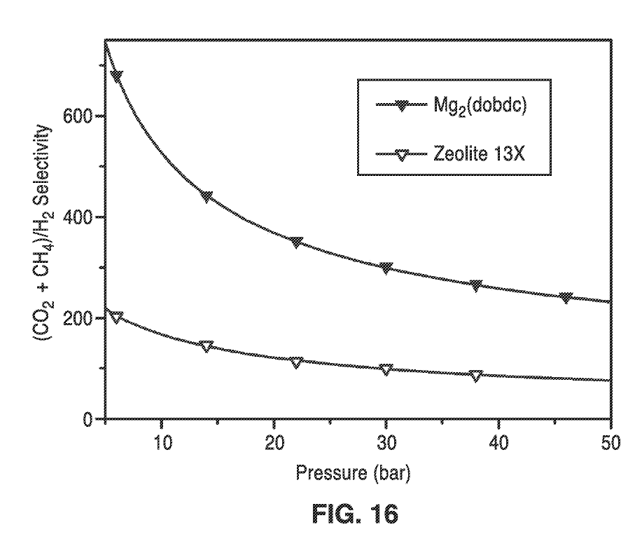

Selectivity for CO₂ and CH₄ in the presence of H₂ is also highly relevant to this separation as well, because CH₄ is a common impurity that is also a greenhouse gas. The selectivity of CH₄ with Mg₂(dobdc) and Zeolite 13X over a range of pressures is shown in FIG. 16. The selectivity of Mg₂(dobdc) is substantially greater than zeolite 13X, particularly at pressures below 10 bar.

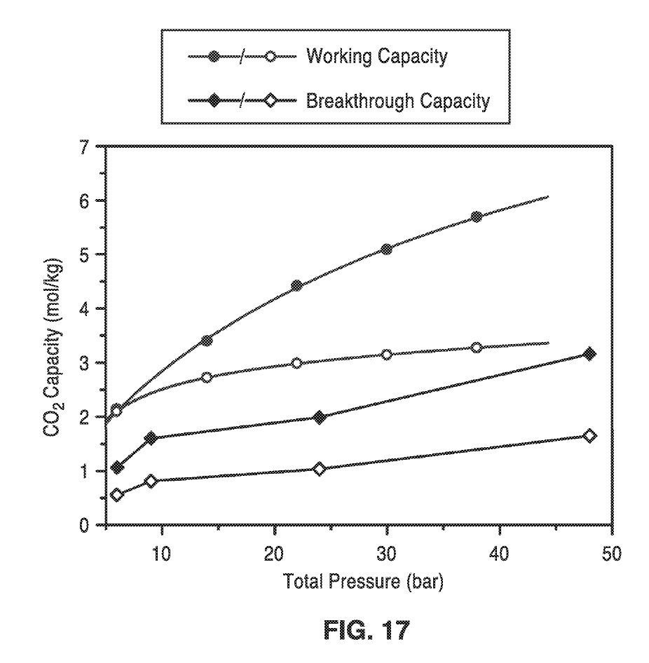

FIG. 17 shows that IAST-calculated gravimetric working capacities for 313 K assuming a purge pressure of 1 bar for CO₂ and CH₄ in a 1:4:20 CH₄:CO₂:H₂ mixture in Mg₂(dobdc) (closed symbols) and Zeolite 13X (open symbols). The diamonds represent the predicted working capacity for a simulated breakthrough with a packed bed of adsorbent.

In concert, the selectivity and working capacity demonstrate that Mg₂(dobdc) outperforms all materials studied in terms of capacity while still maintaining the selectivity similar to Zeolite 13X, as the 313 K data for Mg₂(dobdc) falls between 323 K and 303 K selectivities for Zeolite 13X. In a similar comparison, Cu-BTTri exhibited selectivity values comparable to an activated carbon but demonstrated a much higher working capacity than carbon.

The stability of the proposed metal-organic frameworks under PSA H₂/CO₂ separation conditions, the regenerability by H₂ purge as opposed to pressure drop, and the cost of these materials when synthesized on industrial scales will improve with further investigation. Generally, the regeneration of these metal-organic framework adsorbents is not expected to prevent their use because Mg₂(dobdc) has a similar heat of adsorption to Zeolite 5A, a material regularly used in this process.

While one of the most productive applications of this technology is in pressure-swing adsorption columns using metal-organic frameworks as adsorbents, many other opportunities exist for the use of these materials in H₂/CO₂ separations as well. For example, mixtures of metal-organic frameworks and activated carbons could prove economically ideal, such as seen with mixtures of zeolites and activated carbons are used currently in PSA beds. Additionally, the incorporation of metal-organic frameworks into either H₂- or CO₂-selective membranes is considered feasible. Finally, the use of thermally-stable and hydrolytically-stable metal-organic frameworks in high temperature sorption-enhanced water-gas shift reactions could make use of the advantages of PSA while also increasing the efficiency and decreasing the temperature of the water-gas shift reaction itself.

Low-Pressure Gas Sorption Measurements were used to confirm that the samples maintained a surface area in agreement with (or higher than) those previously reported. Glass sample tubes of a known weight were loaded with approximately 200 mg of sample, and sealed using a TranSeal. Samples were degassed at 100° C. for 24 hours on a Micromeritics ASAP 2020 analyzer until the outgas rate was no more than 1 mTorr/min. The degassed sample and sample tube were weighed precisely and then transferred back to the analyzer (with the TranSeal preventing exposure of the sample to the air after degassing). The outgas rate was again confirmed to be less than 1 mTorr/min. Adsorption isotherms were measured at 77 K in a liquid nitrogen bath for H₂ and N₂, and at 87 K in a liquid argon bath for H₂.

High-Pressure Gas Sorption Measurements were also conducted. In a typical measurement, at least 200 mg of sample was loaded in a sample holder in a glove box under an argon atmosphere. The sample was evacuated at 100° C. for 10 hours under a pressure of less than 10⁻⁵ torr. Hydrogen and carbon dioxide excess adsorption measurements were performed on an automated Sieverts' apparatus (PCTPro-2000 from Hy-Energy Scientific Instruments LLC) over a pressure range of 0-50 bar. UHP-grade hydrogen, carbon dioxide and helium (99.999% purity) were used for all measurements. Total adsorption was calculated using NIST Thermochemical Properties of Fluid Systems: CO₂ and H₂ densities between 0 and 50 bar were fit using a sixth-order polynomial, then multiplied by the pore volume of each material.

The ideal adsorbed solution theory (IAST) of Prausnitz and Myers was used to estimate the composition of the adsorbed phase from pure component isotherm data. Experimental absolute isotherm data were fit to the dual-site Langmuir-Freundlich isotherm for CO₂ adsorption and the single-site Langmuir-Freundlich model for H₂. H₂ saturation capacities were allowed to refine between two and three times the saturation capacity for CO₂, which was confirmed visually. Ideal Adsorbed Solution Theory Validations for CO₂/H₂ Mixtures in Metal-Organic Frameworks were also performed. The accuracy of the IAST for estimation of component loadings for adsorption of a wide variety of binary mixtures in zeolites has been established with the aid of Configurational-Bias Monte Carlo (CBMC) simulations. As illustration of the validity of the use of the IAST for estimation of CO₂/H₂ adsorption equilibrium in MOF's, CBMC results for adsorption of CO₂/H₂ mixtures in MOF-177 were obtained at 313 K, the temperature used in the experimental work. The CBMC simulation methodology is similar to that described in published work. The symbols in FIG. 15A represent the pure component adsorption isotherms for CO₂ and H₂ in MOF-177 obtained from CBMC. The continuous solid lines in FIG. 15A are the dual-Langmuir-Freundlich fits of the isotherms.

The component loadings in an 80:20 H₂:CO₂ mixture at 313 K, determined using CBMC simulations, are presented FIG. 15B as filled symbols. The continuous solid lines are the IAST estimations using the dual-Langmuir-Freundlich fits of the pure component isotherms. It is to be noted that there is excellent agreement between the IAST predictions and the CBMC simulated component loadings in the mixture. This agreement is typical for adsorption of CO₂:H₂ mixtures in MOF's. The present invention provides a method and metal-organic framework materials that act as adsorbents for hydrogen purification and pre-combustion carbon dioxide capture from a pressurized stream of mixed gases by pressure swing adsorption. The metal organic framework materials selectively adsorb carbon dioxide at high pressures in the presence of hydrogen and desorb carbon dioxide upon a decrease of carbon dioxide pressure.

Due to their high surface areas and low bulk densities, these materials demonstrate remarkable working capacities for sequestering carbon dioxide, making them ideal for use in large scale processing plants and a great improvement over current adsorbents. The successful implementation of these new adsorbents could both reduce the substantial energy cost of hydrogen purification and reduce or eliminate CO₂ emissions in the generation of electricity from coal or syngas.

From the discussion above it will be appreciated that the invention can be embodied in various ways, including the following:

1. A method of separating constituent gases from a stream of mixed gases containing a first chemical and a second chemical, said method comprising: contacting a stream of mixed gases containing a first chemical and a second chemical with a metal-organic framework adsorbent comprising M₂ (2,5-dioxido-1,4-benzenedicarboxylate) wherein M=Mg, Mn, Fe, Co, Cu, Ni or Zn; adsorbing molecules of the first chemical to the metal-organic framework to obtain a stream richer in the second chemical as compared to the mixture stream; releasing adsorbed first chemical from the metal-organic framework adsorbent to obtain a stream richer in the first chemical as compared to the mixture stream; and collecting the richer streams of the first chemical and the second chemical.

2. The method of embodiment 1: wherein the first chemical is carbon dioxide; and wherein the second chemical is hydrogen.

3. The method of embodiment 1: wherein the first chemical is oxygen; and wherein the second chemical is nitrogen.

4. The method of embodiment 1: wherein the first chemical is nitric oxide; and wherein the second chemical is nitrous oxide.

5. The method of embodiment 1: wherein the first chemical is an olefin; and wherein the second chemical is a paraffin.

6. The method of embodiment 1: wherein the first chemical is ethane; and wherein the second chemical is ethene.

7. The method of embodiment 1: wherein the first chemical is propane; and wherein the second chemical is propene.

8. The method of embodiment 1: wherein the first chemical is carbon monoxide; and wherein the second chemical is a chemical selected from the group of chemicals consisting essentially of hydrogen, methane, nitrogen and carbon dioxide.

9. The method of embodiment 1, wherein activated carbon particles are combined with particles of the adsorbent.

10. A metal-organic framework adsorbent, comprising an adsorbent selected from the group of adsorbents consisting essentially of Co(BDP), Cu-BTTri, Be-BTB and M₂(2,5-dioxido-1,4-benzenedicarboxylate); wherein M=Mg, Mn, Fe, Co, Cu, Ni or Zn.

11. The metal-organic framework adsorbent recited in embodiment 10, further comprising activated carbon particles combined with particles of said adsorbent.

12. A method for separating carbon dioxide gas from a mixture of gases, said method comprising: providing a stream of mixed gases containing carbon dioxide at a pressure between approximately 5 bar and approximately 40 bar; bringing and maintaining gas stream temperature to a temperature between approximately 300 K and approximately 320 K; exposing the pressurized stream of mixed gases to a contained bed of at least one metal-organic framework carbon dioxide adsorbent; and collecting gases of the pressurized mixed gas stream that are not adsorbed to the metal-organic framework carbon dioxide adsorbent.

13. The method of embodiment 12, further comprising removing the contained bed of at least one metal-organic framework carbon dioxide adsorbent from the pressurized mixed gas stream; lowering the pressure within the contained bed of at least one metal-organic framework carbon dioxide adsorbent; and purging the contained bed of at least one metal-organic framework carbon dioxide adsorbent with a purge gas; wherein the change in partial pressure of carbon dioxide in the contained bed of at least one metal-organic framework carbon dioxide adsorbent and the purge gas desorbs carbon dioxide from the contained bed of at least one metal-organic framework carbon dioxide adsorbent and expels the carbon dioxide from the contained bed.

14. The method of embodiment 13, wherein the purge gas comprises hydrogen gas.

15. The method of embodiment 13, wherein the purge gas is maintained at a pressure of approximately one bar and a temperature between approximately 300 K and approximately 320 K.

16. The method of embodiment 12, wherein the metal-organic framework adsorbent is an adsorbent selected from the group of adsorbents consisting essentially of Co(BDP), Cu-BTTri, Be-BTB and Mg₂(dobdc), and M₂(1,4-dioxido-2,5-benzenedicarboxylate) where M=Mg, Mn, Fe, Co, Cu, Ni or Zn.

17. The method of embodiment 12, wherein the mixed gas is a gas selected from the group of mixed gases consisting essentially of reacted synthesis gas, steam-methane water gas shift reaction products, contaminated hydrogen gas and gaseous carbon fuel combustion products.

18. The method of embodiment 12, wherein the temperature of the mixed gas is maintained at temperature of between approximately 310 K and approximately 315 K.

19. The method of embodiment 12, wherein the temperature of the mixed gas is maintained at temperature of 313 K.

20. The method of embodiment 12, wherein the pressure of the mixed gas is maintained at between approximately 25 bar and approximately 35 bar.

21. The method of embodiment 12, wherein the pressure of the mixed gas is maintained at pressure of 35 bar.

22. A method for separating carbon dioxide gas from synthesis gas, said method comprising: converting biomass or fossil fuels to a stream of synthesis gases; pressurizing said stream of synthesis gases to a pressure between approximately 5 bar and approximately 40 bar; bringing and maintaining the gas stream temperature to a temperature between approximately 300 K and approximately 320 K; exposing said pressurized synthesis gases to a container with a bed of at least one metal-organic framework carbon dioxide adsorbent; collecting gases from said pressurized synthesis gas stream that are not adsorbed to said bed of at least one metal-organic framework carbon dioxide adsorbent; and releasing adsorbed carbon dioxide from said bed of at least one metal-organic framework carbon dioxide adsorbent by reducing the pressure in the bed container.

23. The method of embodiment 22, further comprising purging the bed of at least one metal-organic framework carbon dioxide adsorbent with a purge gas; wherein the change in pressure in the bed of at least one metal-organic framework carbon dioxide adsorbent and the purge gas desorbs carbon dioxide from the adsorbent bed and expels the carbon dioxide from the container.

24. The method of embodiment 23, wherein the purge gas is a gas selected from the group of gases consisting essentially of hydrogen gas, methane gas and synthesis gas.

25. The method of embodiment 23, wherein the purge gas is a gas introduced to the adsorbent bed container at a pressure of approximately 1 bar.

26. The method of embodiment 22, further comprising filtering the synthesis gas prior to pressurization to remove volatile liquids.

27. A method for separating carbon dioxide gas from a mixture of gases, said method comprising: providing a stream of mixed gases containing carbon dioxide; pressurizing the stream of mixed gases to a pressure between approximately 5 bar and approximately 40 bar; bringing and maintaining gas stream temperature to a temperature between approximately 300 K and approximately 320 K; exposing the pressurized mixed gases to a contained bed of at least one metal-organic framework carbon dioxide adsorbent; collecting gases of the pressurized mixed gas stream that are not adsorbed to the contained bed of at least one metal-organic framework carbon dioxide adsorbent for a first period of time; closing the flow of pressurized mixed gas to the contained bed of at least one metal-organic framework carbon dioxide adsorbent; reducing the pressure of the contained bed of at least one metal-organic framework carbon dioxide adsorbent for a second period of time; purging said contained bed of at least one metal-organic framework carbon dioxide adsorbent sequestered in said adsorbent by opening the flow of pressurized mixed gas stream; and collecting purged gases from the contained bed of at least one metal-organic framework carbon dioxide adsorbent.

28. A method of storing acetylene, said method comprising: adsorbing acetylene gas with a Fe₂(1,4-dioxido-2,5-benzenedicarboxylate) framework.

29. A method of oxidizing a material, said method comprising: contacting the material with Fe₂(1,4-dioxido-2,5 benzenedicarboxylate).

30. A method of making Fe₂(1,4-dioxido-2,5-benzenedicarboxylate), said method comprising: reacting FeCl₂ with H₄(1,4-dioxido-2,5-benzenedicarboxylate) in a reaction mixture to produce Fe₂(1,4-dioxido-2,5-benzenedicarboxylate).

31. The method of embodiment 30, wherein the reaction mixture comprises dimethylformamide (DMF) and methanol.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. A method of separating constituent gases from a stream of mixed gases containing a first chemical and a second chemical, said method comprising:
contacting a stream of mixed gases containing a first chemical and a second chemical with a metal-organic framework adsorbent comprising M₂ (2,5-dioxido-1,4-benzenedicarboxylate) wherein M=Mg, Mn, Fe, Co, Cu, Ni or Zn;
adsorbing molecules of the first chemical to the metal-organic framework to obtain a stream richer in the second chemical as compared to the mixture stream;
releasing adsorbed first chemical from the metal-organic framework adsorbent to obtain a stream richer in the first chemical as compared to the mixture stream; and
collecting said richer streams of the first chemical and the second chemical.

2. A method as recited in claim 1:
wherein the first chemical is carbon dioxide; and
wherein the second chemical is hydrogen.

3. A method as recited in claim 1:
wherein the first chemical is oxygen; and
wherein the second chemical is nitrogen.

4. A method as recited in claim 1:
wherein the first chemical is nitric oxide; and
wherein the second chemical is nitrous oxide.

5. A method as recited in claim 1:
wherein the first chemical is an olefin; and
wherein the second chemical is an paraffin.

6. A method as recited in claim 1:
wherein the first chemical is ethane; and
wherein the second chemical is ethene.

7. A method as recited in claim 1:
wherein the first chemical is propane; and
wherein the second chemical is propene.

8. A method as recited in claim 1:
wherein the first chemical is carbon monoxide; and
wherein the second chemical is a chemical selected from the group of chemicals consisting essentially of hydrogen, methane, nitrogen and carbon dioxide.

9. A method as recited in claim 1, wherein activated carbon particles are combined with particles of said adsorbent.

10. A metal-organic framework adsorbent, comprising:
an adsorbent selected from the group of adsorbents consisting essentially of Co(BDP), Cu-BTTri, Be-BTB and M₂(2,5-dioxido-1,4-benzenedicarboxylate); wherein M=Mg, Mn, Fe, Co, Cu, Ni or Zn.

11. A metal-organic framework adsorbent as recited in claim 10, further comprising activated carbon particles combined with particles of said adsorbent.

12. A method for separating carbon dioxide gas from a mixture of gases, said method comprising:
providing a stream of mixed gases containing carbon dioxide at a pressure between approximately 5 bar and approximately 40 bar;
bringing and maintaining gas stream temperature to a temperature between approximately 300 K and approximately 320 K;
exposing said pressurized stream of mixed gases to a contained bed of at least one metal-organic framework carbon dioxide adsorbent; and
collecting gases of said pressurized mixed gas stream that are not adsorbed to the metal-organic framework carbon dioxide adsorbent.

13. A method as recited in claim 12, further comprising:
removing the contained bed of at least one metal-organic framework carbon dioxide adsorbent from the pressurized mixed gas stream;
lowering the pressure within the contained bed of at least one metal-organic framework carbon dioxide adsorbent; and
purging the contained bed of at least one metal-organic framework carbon dioxide adsorbent with a purge gas;
wherein the change in partial pressure of carbon dioxide in said contained bed of at least one metal-organic framework carbon dioxide adsorbent and said purge gas desorbs carbon dioxide from the contained bed of at least one metal-organic framework carbon dioxide adsorbent and expels the carbon dioxide from the contained bed.

14. A method as recited in claim 13, wherein said purge gas comprises hydrogen gas.

15. A method as recited in claim 13, wherein said purge gas is maintained at a pressure of approximately one bar and a temperature between approximately 300 K and approximately 320 K.

16. A method as recited in claim 12, wherein said metal-organic framework adsorbent is an adsorbent selected from the group of adsorbents consisting essentially of Co(BDP), Cu-BTTri, Be-BTB and Mg₂(dobdc), and M₂(1,4-dioxido-2,5-benzenedicarboxylate) where M=Mg, Mn, Fe, Co, Cu, Ni or Zn.

17. A method as recited in claim 12, wherein said mixed gas is a gas selected from the group of mixed gases consisting essentially of reacted synthesis gas, steam-methane water gas shift reaction products, contaminated hydrogen gas and gaseous carbon fuel combustion products.

18. A method as recited in claim 12, wherein said temperature of said mixed gas is maintained at temperature of between approximately 310 K and approximately 315 K.

19. A method as recited in claim 12, wherein said temperature of said mixed gas is maintained at temperature of 313 K.

20. A method as recited in claim 12, wherein said pressure of said mixed gas is maintained at between approximately 25 bar and approximately 35 bar.

21. A method as recited in claim 12, wherein said pressure of said mixed gas is maintained at pressure of 35 bar.

22. A method for separating carbon dioxide gas from synthesis gas, said method comprising:
converting biomass or fossil fuels to a stream of synthesis gases;
pressurizing said stream of synthesis gases to a pressure between approximately 5 bar and approximately 40 bar;
bringing and maintaining the gas stream temperature to a temperature between approximately 300 K and approximately 320 K;
exposing said pressurized synthesis gases to a container with a bed of at least one metal-organic framework carbon dioxide adsorbent;
collecting gases from said pressurized synthesis gas stream that are not adsorbed to said bed of at least one metal-organic framework carbon dioxide adsorbent; and
releasing adsorbed carbon dioxide from said bed of at least one metal-organic framework carbon dioxide adsorbent by reducing the pressure in the bed container.

23. A method as recited in claim 22, further comprising:
purging the bed of at least one metal-organic framework carbon dioxide adsorbent with a purge gas;
wherein the change in pressure in said bed of at least one metal-organic framework carbon dioxide adsorbent and said purge gas desorbs carbon dioxide from the adsorbent bed and expels the carbon dioxide from the container.

24. A method as recited in claim 23, wherein said purge gas is a gas selected from the group of gases consisting essentially of hydrogen gas, methane gas and synthesis gas.

25. A method as recited in claim 23, wherein said purge gas is a gas introduced to said adsorbent bed container at a pressure of approximately 1 bar.

26. A method as recited in claim 22, further comprising:
filtering the synthesis gas prior to pressurization to remove volatile liquids.

27. A method for separating carbon dioxide gas from a mixture of gases, said method comprising:
providing a stream of mixed gases containing carbon dioxide;
pressurizing said stream of mixed gases to a pressure between approximately 5 bar and approximately 40 bar;
bringing and maintaining gas stream temperature to a temperature between approximately 300 K and approximately 320 K;
exposing said pressurized mixed gases to a contained bed of at least one metal-organic framework carbon dioxide adsorbent;
collecting gases of said pressurized mixed gas stream that are not adsorbed to the contained bed of at least one metal-organic framework carbon dioxide adsorbent for a first period of time;
closing the flow of pressurized mixed gas to the contained bed of at least one metal-organic framework carbon dioxide adsorbent;
reducing the pressure of the contained bed of at least one metal-organic framework carbon dioxide adsorbent for a second period of time;
purging said contained bed of at least one metal-organic framework carbon dioxide adsorbent sequestered in said adsorbent by opening the flow of pressurized mixed gas stream; and
collecting purged gases from said contained bed of at least one metal-organic framework carbon dioxide adsorbent.

28. A method of storing acetylene, said method comprising:
adsorbing acetylene gas with a Fe₂(1,4-dioxido-2,5-benzenedicarboxylate) framework.

29. A method of oxidizing a material, said method comprising:
contacting the material with Fe₂(1,4-dioxido-2,5 benzenedicarboxylate).

30. A method of making Fe₂(1,4-dioxido-2,5-benzenedicarboxylate), said method comprising:
reacting FeCl₂ with H₄(1,4-dioxido-2,5-benzenedicarboxylate) in a reaction mixture to produce Fe₂(1,4-dioxido-2,5-benzenedicarboxylate).

31. A method as recited in claim 30, wherein the reaction mixture comprises dimethylformamide (DMF) and methanol.
